(19) United States
(12) Patent Application Publication
(10) Pub. No.: US 2018/0235213 A1
(43) Pub. Date: Aug. 23, 2018

(54) PLANT HORMONE APPLICATION

(71) Applicant: The State of Israel Ministry of Agriculture & Rural Develop. Agricultural Research Organization, Beit-Dagan (IL)

(72) Inventors: Hinanit KOLTAI, Rishon Lezion (IL); Yoram KAPULNIK, Carmei Yosef (IL); Smadar WEININGER, Rishon Lezion (IL)

(21) Appl. No.: 15/573,895

(22) PCT Filed: May 11, 2016
(86) PCT No.: PCT/IL2016/050504

§ 371 Date: Nov. 14, 2017

(30) Foreign Application Priority Data
May 14, 2015 (IL) 238839

(51) Int. Cl. A01N 25/34; A01N 25/10; A01N 43/12; A01N 43/38

(52) U.S. Cl. CPC A01N 25/34; A01N 43/38; A01N 43/12; A01N 25/10

(57) ABSTRACT

A composition comprising at least one polymer, characterized by a surface energy having a value that ranges from 20 mJ/m² to 60 mJ/m², and an active agent (e.g., a plant hormone) is disclosed. A delivery device comprising the disclosed composition, adapted for installation on a part of a plant, is further disclosed. A method for applying a plant hormone to a plant is further disclosed.

This application claims priority from IL Patent Application No. 238839, filed on May 14, 2015. The content of the above document is incorporated by reference as if fully set forth herein.

### FIELD OF THE INVENTION

The invention relates, inter alia, to a delivery device and method for the application of active agents such as plant hormones to a plant.

### BACKGROUND OF THE INVENTION

Different levels of apical dominancy ensure continuous growth and plant design necessary for agriculture. This is true of vegetables, ornamental woody plants and fruit trees. In many of these plants one of the problems is vegetative growth of side branches, termed axillary branches, which require removing constantly. In olives and many other fruit trees, apical dominance is essential in the first stage of growth in the nursery (following rooting and hardening), for the development of one bud only to apical branch. However, in most cases, multiple buds develop simultaneously, thus requiring the investment of manpower for pruning these axillary branches. Other plants such as ornamental plants and fruit trees require defined architecture, which may add value to the determined product. In most of these plants it is necessary to create a section without axillary branching at the base of the stem. Prevention of branching of the plant requires considerable investment and farm work using valuable manpower.

Olive (Olea europaea L.), as a non-limiting example, is one of the most important tree crop species of the Mediterranean area. These are small tree or shrub that grows up to 8-15 meters tall. The fruit of olive trees are used as fruits or for olive oil, which is generally used for cooking, cosmetics and different medicinal applications. In total, about 11,000 tons of olive oil is produced annually. On the tree branches, nodule segments contain two leaves, in each a single bud. Inflorescence and flower differentiation occur in the early spring following a period of winter chilling and dormancy of the vegetative and reproductive buds.

Apart from their benefits, one of the difficulties with olive cultivation is obtaining desired growth architecture. Olive seedlings grow in a bushy structure, not desired at early stages of development. This natural growth architecture requires constant and costly trimming of axillary buds by the farmers.

Plant surfaces play a crucial role in protecting organs against an array of biotic and abiotic stress factors such as the uncontrolled loss of water. On the other hand, plant surface, being hydrophilic, provide permeability to liquids so as to enable absorption of, for example, liquid water, fog and dew. These will be influenced by the wettability and adhesion or repellence of water drops onto plant surfaces.

Natural strigolactones (SLs) are a group of plant hormones shown to act as long-distance branching factors, suppressing the outgrowth of axillary buds in the shoot. Hence, they are prominent effectors of apical dominance in plants. Present in a wide variety of plant species, SLs are derived from carotenoids and are biosynthesized through several steps. Root development of seedlings has been shown to be also regulated by SL activity. They are also involved in plant communication in the rhizosphere, and act as stimulants of parasitic plant (Striga and Orobanche) seed germination and as stimulants of arbuscular mycorrhizal fungi hyphal branching.

Several structural analogs of the naturally occurring strigolactones have been synthesized, and were found to retain the biological activity of the natural hormones. These synthetic compounds are easier to produce in large amounts compared to the natural strigolactones, and are therefore economically more suitable for large scale application to plants.

There is a long-felt need to control the level of branching in plants so as to provide many agricultural benefits, including reduced labor, improved product quality and increased profitability.

### SUMMARY OF THE INVENTION

The invention relates to a polymeric composition comprising an active agent, a delivery device comprising same, and to a method for the application of active agents such as plant hormones to a plant.

According to one aspect, there is provided a composition comprising at least one polymer characterized by a surface energy having a value that ranges from 20 mJ/m² to 60 mJ/m², and an active agent. In some embodiments, the active agent is a plant hormone. In some embodiments, the plant hormone is at a concentration that ranges from 3 mg/L to 30 mg/L.

In some embodiments, the at least one polymer is selected from the group consisting of polyvinyl acetate (PVAc), polyvinyl alcohol (PVA), hydroxypropyl cellulose (HPC), hydroxy ethyl cellulose (HEC), polyvinyl pyrrolidone (PVP), polyethylene, and glycol (PEG), or any combination thereof. In some embodiments, the polymer is HPC. In some embodiments, the polymer is polyvinyl chloride (PVC).

In some embodiments, the composition further comprises a plasticizer. In some embodiments, the plasticizer is in the range of 30% to 50%, by weight of the composition. In some embodiments, the plasticizer is a polymer having a molecular weight (MW) of less than 1000 gr/mole. In some embodiments, the plasticizer is PEG. In some embodiments, the plasticizer is glycerin. In some embodiments, the polymer is HPC and the plasticizer is glycerin. In some embodiments, the polymer is PVC and the plasticizer is PEG.

According to another aspect, there is provided an article comprising the disclosed composition in any embodiment thereof. In some embodiments, the article is a delivery device. In some embodiments, the article is adapted for installation on a part of a plant, thereby enabling the application of the composition to the plant.

In some embodiments, the delivery device is configured to wrap the part of the plant.

In some embodiments, the delivery device has a cylindrical form, a tube form, a ring form or a clamp form.

In some embodiments, the delivery device is made of a rigid, semi-rigid or a flexible material, or any combinations thereof.

In some embodiments, the delivery device is made of a biodegradable polymer, composed of pure or blends of bio-plastics. In some embodiments, the biodegradable polymer comprises or is produced from corn starch, potato starch, agar, gelatin, PLA (polylactic acid) or PLGA (poly(lactic-co-glycolic acid)).

In some embodiments, the part of the plant is the stem, the bud, the root stock, the trunk, the stalk, or any part of the shoot of the plant.

In some embodiments, the active agent is a plant hormone being a compound of formula I:

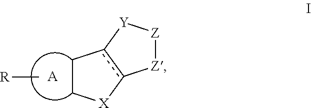

wherein:
A is an aromatic or non-aromatic 5, 6, or 7 carbon atom membered ring;
X is CH₂, NH, or NR′;
Y is CH₂ or O;
Z is CO or -(4-methyl-5-oxo-2,5-dihydrofuran-2-yloxy)-methylene;
Z′ is CO or -(4-methyl-5-oxo-2,5-dihydrofuran-2-yloxy)-methylene;
R is aryl, heteroaryl, NH₂, NHR′, NR′₂, or alkyl;
R′ is aromatic or heteroaromatic ring or alkyl;
or pharmaceutically acceptable salts thereof.

In some embodiments, the plant hormone is a compound of formula II:

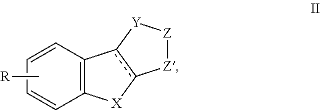

wherein

X is CH₂, NH, or NR′;

Y is CH₂ or O;

Z is CO or -(4-methyl-5-oxo-2,5-dihydrofuran-2-yloxy)-methylene;

Z′ is CO or -(4-methyl-5-oxo-2,5-dihydrofuran-2-yloxy)-methylene;

R is aryl, heteroaryl, NH₂, NHR′, NR′₂, or alkyl;

R′ is aromatic or heteroaromatic ring or alkyl;

or pharmaceutically acceptable salts thereof.

In some embodiments, the compound of formula I is selected from Strigol, Strigyl acetate, Sorgolactone, Orobanchol, Orobanchyl acetate, 5-Deoxystrigol, 2′-Epiorobanchol, Sorgomol, 7-Oxoorobanchol, Solanacol, Fabacyl acetate, Alectrol, 7-Hydroxyorobanchol, 7-Oxoorobanchyl acetate, and 7-Hydroxyorobanchyl acetate.

In some embodiments, the plant hormone is a strigolactone analog. In some embodiments, the strigolactone analog is selected from the group consisting of EGO10, GR24, and ST362.

In some embodiments, the plant hormone is EGO10, the medium compound is HPC and the plasticizing agent is glycerin.

According to another aspect, there is provided a method for applying a plant hormone to a plant, the method comprising providing the article or composition described herein to a plant. In one embodiment, the providing the composition is contacting the plant with the delivery device of the invention, the delivery device comprises the composition of the invention.

According to another aspect, there is provided a method for applying a plant hormone to a plant, the method comprising providing a delivery device adapted to contain a plant hormone formulation, and installing the delivery device on a part of the plant, wherein the plant hormone formulation is provided prior to and/or after the installation of the device.

In some embodiments, the plant hormone formulation is provided by filling the device.

In some embodiments, the method comprises sealing the delivery device containing the plant hormone formulation.

According to an aspect of some embodiments of the present invention, there is provided a composition comprising a natural strigolactone or a strigolactone analog, a polymeric compound, and a plasticizer, for use in decreasing or preventing axillary bud growth in a plant.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIGS. 1A-1B show the effect of application by irrigation of the synthetic SL analog GR24 on apical dominance in Picual olives. GR24 was applied at a concentration of 0.03 and 0.3 μM twice a week. Each treatment was repeated three times. Values are means±SE. FIG. 1A is a graph showing the number of growing buds following GR24 treatments and control. 10 plants were measured for each treatment. Each bar in the triplet of bars, the left bar refers to Day 1, the middle bar refers to Day 54 and the right bar refers to Day 185 FIG. 1B shows a representative example of treated and control olives seedlings. Hereinthroughout, “a” (or “A) and “b” (or “B”) on the bars are defined to denote statistically independency of each bar.

FIGS. 2A-2B are graphs showing the effect of application by irrigation of synthetic SL analogs ST362 (FIG. 2A) and EGO10 (FIG. 2B) on apical dominance in Picual olives. Analogs were applied at a concentration of 0.03 μM twice a week. Number of growing buds is shown. For each treatment (treated and control groups) 10 plants were measured. Values are means±SE. Different lower case letters above columns represent significantly different means (P≤0.05).

FIGS. 3A-3B are graphs showing the effect of EGO10 application with and without hydroxypropyl cellulose (HPC) on Orobanche germination %. Values are means±SE. Different lower case letters above columns represent significantly different means (P≤0.05). FIG. 3A shows the effect on germination % at different pH conditions. FIG. 3B shows the effect on germination % at 60° C. for incubation times of 0 and 24 hours.

FIGS. 4A-4C shows the plate bioassay developed for examination of bud outgrowth in olive cuttings. FIG. 4A shows the divided plate with an olive cutting placed in an agar cube containing SL analog (or acetone control). FIG. 4B shows the node that contains two buds. FIG. 4C shows the way bud outgrowth was measured on each node. Bar denotes 1000 μm.

FIG. 5 is a graph showing the effect of EGO10 (5 μM) supplied in an agar cube to the base of the cutting of olive seedling on bud growth. Y axis represents the length of the bud minus its length at the first day following application. X axis represents the bud position, down or up, and the treatment (Con-ConAc or Con-Ego). Abbreviations: Con-ConAc (upper part of plate contain ½MS water, lower part (agar cube) contains ½MS acetone control); Con-Ego (upper part of the plate contain ½MS water agar, lower part (cube) ½MS EGO10); MS: Murashige and Skoog. Values are means±SE.

FIGS. 6A-6B shows the bud growth effect of 5 μM EGO10, applied by agar cube placed on the bark of the cutting of olive seedling. FIG. 6A shows a plate experiment in which an agar cube was placed on the cutting bark. Circles represent examined buds. FIG. 6B is a graph showing the results of bud outgrowth following 96, 168 and 264 hours (h) of EGO10 treatment. Y axis represents the length of the upper bud minus its length at the first day following application. X axis represents treatment and its duration. Values are means±SE. Different letters above columns represent significantly different means (P≤0.05). Abbreviations: Con-Ac (plate containing ½MS water agar, agar cube containing ½MS acetone control); Con-EGO10 (plate contains ½MS water agar, agar cube contains ½MS EGO10).

FIG. 7 shows the effect of scratches on the olive seedling cuttings. Arrows denote callus formation on the stem. Bar is 1000 μm.

FIG. 8 is a bar graph showing the bud growth effect of EGO10 (5 μM) applied by agar cube on the bark of the cutting of olive seedling after 264 hour treatment. Y axis represent the length of the upper bud minus its length at the first day following application. X axis represents the different treatments. Values are means±SE. Different letters above columns represent significantly different means (P≤0.05). Abbreviations: Con-Ac (plate containing ½MS water, agar cube containing ½MS acetone control) Con-EGO10 (plate containing ½MS water agar, agar cube containing ½MS EGO10). * bark was scratched.

FIG. 9 shows a picture demonstrating different percentages of HPC in water applied on olive stem.

FIG. 10 shows a picture of a plate on which 30% HPC with EGO10 were applied on cut olive stem.

FIG. 11 is a bar graph showing the effect of EGO10 (5 μM and 10 applied in agar cube or HPC on the bark of olive cuttings, on bud growth. Y axis represents the length of the upper bud minus its length at the first day following application. X axis represents the different treatments. Results of 96 h (4 d), 168 h (7 d) and 264 h (12 d) are shown. Values are means±SE. Different letters above columns represent significantly different means (P≤0.05). Abbreviations: HPC (plate containing ½MS water agar and HPC applied with acetone); HPC+EGO10 (plate containing ½MS water, agar and HPC applied with EGO10); Con-Ac, (plate containing ½MS water, agar cube containing ½MS acetone control); Con-EGO10 (plate containing ½MS water agar, agar cube containing ½MS EGO10).

FIG. 12 is a bar graph showing the effect of EGO10 (5 μM) on bud growth applied in HPC mixed with glycerin (3:1) on the bark of the olive cuttings. Y axis represents the length of the upper bud minus its length at the first day following application. X axis represents plates containing ½MS water agar, HPC and glycerin, either with acetone (Ac) or EGO10. Results of 96 h (4 days), 168 h (7 days) and 264 h (12 days) are shown. Values are means±SE. Different letters above columns represent significantly different means (P≤0.05). Abbreviations: AC (acetone control).

FIG. 13 is a graph showing the effect of EGO10 (5 μM) on bud growth supplied in 30% Polyvinyl acetate (PVAc) on the bark of the olive cuttings. Y axis represents the length of the upper bud minus its length at the first day following application. X axis represents plates containing ½MS water agar and PVAc, either with acetone (Ac) or EGO10. Results of 96 h (4 days), 168 h (7 days) and 264 h (12 days) are shown. Values are means±SE. Different letters above columns represent significantly different means (P≤0.05). Abbreviations: AC (acetone control).

FIGS. 14A-14C are graphs showing the effect of EGO10 (5 μM) on bud growth. Y axis represents the length of the upper bud minus its length at the first day following application. X axis represents plates containing ½MS water agar and the medium, either with acetone (Ac) or EGO10. Results of 96 h (4 days), 168 h (7 days) and 264 h (12 days) are shown. Values are means±SE. Different letters above columns represent significantly different means (P≤0.05). Abbreviations: AC (acetone control). FIG. 14A shows the effect of EGO10 (5 μM) supplied in 30% HEC on the bark of the olive cuttings. FIG. 14B shows the effect of EGO10 (5 μM) on bud growth supplied in PVA:HEC (2:1) on the bark of the olive cuttings. Y axis—the length of the upper bud minus its length at the first day following application. X axis—Plate contains ½MS water agar and PVA:HEC (2:1), with acetone (Ac) or EGO10. FIG. 14C shows the effect of EGO10 (5 μM) supplied in PVA: PVP (2:1) on the bark of the olive cuttings. Y axis—the length of the upper bud minus its length at the first day following application. X axis—Plate contains ½MS water agar and PVA: PVP (2:1), with acetone (Ac) or EGO10.

FIGS. 15A-15D are pictures showing the application of EGO10 or Ac (acetone control) under greenhouse conditions of control olive seedling (FIG. 15A); EGO10 and the substance (HPC+glycerin or PVA) applied on the stem (FIG. 15B); (HPC+glycerin, or PVAc) treatment with parafilm cover (marked by an arrow) (FIG. 15C); and following one day only HPC+Glycerin liquefies on the stem (FIG. 15D).

FIGS. 16A-16F are pictures showing representative examples showing the stages of application of EGO10 (with or without an additional substance) or acetone control by flexible plastic cylinder tubes onto olive seedling under greenhouse conditions. FIG. 16A shows the cut plastic tube. FIG. 16B shows the installation of the tube on the olive stem. FIG. 16C shows the tube sealed with transparent plaster. FIG. 16D shows the partially filled tube with the substance and active compound or control. FIG. 16E shows the partially filled tube with the substance and active compound or control. FIG. 16F shows the tube sealed on both sides with cotton wool.

FIGS. 17A-17E are pictures showing representative examples showing the stages of application of EGO10 (with or without an additional substance) or acetone control by eppendorf tubes onto olive seedling under greenhouse conditions. FIG. 17A shows the installation of the tube on the olive stem. FIG. 17B shows the tube with cotton on the bottom of the tube. FIG. 17C shows the tube filled with the experimental material. FIG. 179D is a close up photograph of FIG. 19C. FIG. 17E shows the tube covered with transparent plastic tape.

FIG. 18 is a bar graph showing the bud growth effect of EGO10 (10 μM) or acetone control supplied in HPC+glycerin, or PVAc on the stem of olive cuttings under greenhouse conditions. Y axis represents the length of the upper bud minus its length at the first day following application. X axis represents the different treatments. Results of 30 days are shown. Values are means±SE. Different letters above columns represent significantly different means (P≤0.05). Abbreviations: AC (acetone), HPC (HPC+glycerin).

FIG. 19 is a bar graph showing the bud outgrowth inhibitory effect of 50 μM EGO10 or acetone control supplied in HPC+glycerin on the stem of olive cuttings under greenhouse conditions. Y axis represents the length of the upper bud minus its length at the first day following application. X axis represents the different treatments. Results of 30 days are shown. Values are means±SE. Different letters above columns represent significantly different means (P≤0.05). Abbreviations: AC (acetone control), HPC (HPC+glycerin).

FIGS. 20A-20F show pictures presenting representative examples showing the steps of the application of EGO10 (with or without an additional substance) or acetone control by rigid tubes onto olive seedling under commercial nursery conditions. FIG. 20A shows the installation of the tube on the olive stem. FIG. 20B shows the fixation of the tube on the stem by coverage of the external side of the tube with cello tape. FIG. 20C shows the filling up of the tube with the experimental material. FIG. 20D shows the tube completely filled with the experimental material. FIG. 20E shows the filled tube covered with cotton on the upper side. FIG. 20F shows the complete experimental set up.

FIG. 21 is a bar graph showing the bud outgrowth inhibitory effect of 50 μM EGO10+HPC+glycerin or acetone control+HPC+glycerin applied via rigid plastic tubes to the stem of olive cuttings under commercial nursery conditions. Y axis represents the number of wake up buds. X axis represents the different treatments. The results of 75 days are shown. Values are means±SE. Different letters above columns represent significantly different means (P≤0.05).

FIG. 22 is a photograph showing the effects of EGO10 treatment on seedling architecture and growth compared to control olive plants.

FIGS. 23A-23B show the application site of the tube after termination of the experiment and removal of the tube. FIG. 23A: Arrow points to the application site on the bark. FIG. 23B: Arrow points to the vascular system of the plant.

FIG. 24 is a photograph showing treated Hypericum plants.

FIG. 25 is a graph showing the bud outgrowth inhibitory effect of 25 μM and 50 μM EGO10 with HPC+glycerin, and a control of HPC applied via collars to the branches of Rose (Rosa hybrida) plants under commercial nursery conditions. Y axis represents the number of side (axillary) branches. X axis represents the different treatments. The results of 25 days are shown. Values are means±SE.

FIG. 26 is a graph showing the number of axillary (side) branches following application of 25 μM and 50 μM EGO10 with HPC+glycerin (abbreviated “25 μM” and “50 μM”, respectively) or acetone control+HPC+glycerin (abbreviated “HPC”) applied via collars to the stem of roses. Y axis number of axillary (side) branches. X axis represents the different treatments. Values are means±SE.

FIG. 27 is a photograph showing an example of the effect of treatment with EGO10 as collar of 50 μM (right) on side branching, in comparison to control (left). the collar comprises HPC+glcerin and EGO10.

FIG. 28 is a bar graph showing the number of axillary branches in Pomegranate following treatments with collar of 50 μM EGO10.

FIG. 29 is a bar graph showing the number of axillary branches in Almond following treatments with EGO10 as granules and collar of 50 μM.

FIG. 30 is a photograph presenting an example of Almond tree treated with EGO10 granules (left) and control (right).

FIG. 31 is a photograph presenting branch length (cm) in Koroneiki olives following treatments with EGO10 as granules and collars of 50 μM EGO10.

FIG. 32 presents photographs showing examples of collar application (left; arrow) on tomato and the experiment in the greenhouse.

FIGS. 33A-33B are bar graphs showing branch weight (grams) in tomato cultivars Shirez (FIG. 33A) and Ikram (FIG. 33B) following treatments with EGO10 as granules, via irrigation and collars of 25 and 50 μM EGO10.

FIG. 34 is a bar graph showing the number of fruits in tomato cultivars Ikram following treatments with EGO10 as granules, via irrigation and collars of 25 μM.

FIGS. 35A-35B are bar graphs showing branch weight (grams) in tomato cultivars Ikram (A) and Shirez (B) and following treatments with EGO10 via irrigation and collars of 500 μM EGO10.

FIGS. 36A-35C are bar graphs showing side braches length (cm) in tomato cultivars Ikram in day 1 (FIG. 36A), after 9 days (FIG. 36B) and after 34 days (FIG. 36C) in the upper segment of the plant (above EGO10 collar) and following treatments with EGO10 via collars of 50 μM (50), EGO10 via collars of 50 μM and Auxin daily spray of 5 ppm (50+AUX), Auxin daily spray of 5 ppm (AUX) and a control. Different letters on columns represent statistical variance between the treatments.

FIG. 37 is a bar graph showing tomatoes fresh weight (g) and following treatments with EGO10 via collars of 50 of 50 μM (50), EGO10 via collars of 50 μM and Auxin daily spray of 5 ppm (50+AUX), Auxin daily spray of 5 ppm (AUX) and a control. Same letters on columns represent no statistical variance between the treatments.

FIGS. 38A-38C are photographs showing collar covers of various polymeric composition as detailed in Table 4 hereinbelow.

FIGS. 39A-3911 are photographs showing collar covers of various polymeric composition on tomato plants as detailed as follows: HPC+40% Glycerol (FIG. 39A); PEG (MW 100,000) (FIG. 39B); PEG (FIG. 39C); PEG 100,000+PEG 600 (FIG. 39D); PVC+50% PEG 600 (FIG. 39E); PLA+30% DOS (FIG. 39F); DOS+30% Ethroxy ethanol (FIG. 39G); and DOS (30%) in PLA (FIG. 39H). DOS: dioctyl sebacate.

FIGS. 40A-40B are bar graphs showing Side braches length (cm) in tomato cultivars Ikram On day 1 (FIG. 40A), and on day 7 (FIG. 40B) in the upper segment of the plant (above EGO10 collar) and following treatments with EGO10 via collars of 50 μM (50+iaa), EGO10 via polymers collars of 50 μM (POL1+IAA, POL2+IAA, POL3+IAA) and Auxin daily spray of 5 ppm (50+AUX), and a control. Different letters on columns represent statistical variance between the treatments. “IAA” refers to auxin (a plant hormone; AUX).

### DETAILED DESCRIPTION OF THE INVENTION

The invention relates to a composition, a delivery device and a method for the application of active agents, such as plant hormones, to a plant.

Specifically, an embodiment of the invention relates to application of compositions, or delivery devices comprising the compositions (also referred to as: “formulation”) comprising strigolactone and/or strigolactone analogs and at least one additive compound.

The Polymeric Composition

According to some embodiments, the present invention provides a composition comprising at least one polymer.

The terms “composition” and “polymeric composition” are used hereinthroughout interchangeably.

As used herein, the term “polymer” describes an organic substance having polymeric backbone composed of a plurality of repeating structural units (monomeric units) covalently connected to one another.

In some embodiments, the repeating structural units refers to alternating copolymers with regular alternating monomeric units (designated as “A₁” and “A₂”).

In some embodiments, the polymeric backbone comprises periodic copolymers with A₁ and A₂ units arranged in a repeating sequence (e.g., A₁-A₂-A₁-A₂-A₂-A₁-A₁-A₁-A₁-A₂-A₂-A₂).

In some embodiments, the polymeric backbone comprises statistical copolymers. As used herein, “statistical copolymers” are copolymers in which the sequence of monomer residues follows a statistical rule. In some embodiments, the polymeric backbone comprises block copolymers. As used herein, block copolymers comprise two or more homopolymer subunits linked by covalent bonds.

In some embodiments, the polymer is water-soluble (also referred to as: “hydrophilic”). In some embodiments, the polymer is water-insoluble (also referred to as: “hydrophobic”).

In some embodiments, the composition is hydrophilic.

Without being bound by any particular mechanism, the hydrophilicity of the composition may assist the mobility of hydrophobic active agent (incorporated within the composition) onto the composition's surface (e.g., in a sustained or controlled release manner).

In some embodiments, the composition comprises a hydrophilic polymer. In some embodiments, the composition comprises a hydrophobic polymer and a hydrophilic plasticizer. Non-limiting exemplary plasticizers are described hereinbelow.

In some embodiments, the term “water-insoluble” is defined to mean that less than e.g., 5 gr, 4 gr, 3 gr, 2 gr, 1 gr, 0.5 gr, 0.4, gr, 0.3 gr, 0.2 gr, or 0.1 gr of the polymeric domain is soluble in 100 gr of water. In some embodiments, the hydrophobicity characteristic is maintained at a defined range of temperature (e.g., 20° C. to 40° C.).

In some embodiments, the polymer is configured to be attachable to a plant surface. In some embodiments, the term “plant surface” is defined as the outermost structuring of part of a plant, formed by the topography of e.g., epidermal cells with its overlying cuticle and/or additional coverings, e.g. wax layers to the surface. In some embodiments, the term “part of a plant” refers to the stem, the bud, the root stock, the trunk, the stalk, or any part of the shoot.

In some embodiments, the water-soluble polymer(s) forms a layer (film) which adheres to the plant surface. The terms “film(s)” and “layer(s)” are used herein interchangeably and refer to a substantially uniform-thickness of a substantially homogeneous substance.

The chemistry and morphological properties of the films are discussed hereinbelow in the Example section. According to some embodiments of the present invention, the layer is homogenized deposited on a plant surface.

In some embodiments, the film of the disclosed polymer(s) is characterized by a thickness of 0.1 micron to 100 micron, e.g., 20 to 50 microns.

In some embodiments, the film of the disclosed polymer(s) is characterized by a thickness of 1 micron, 5 microns, 10 microns, 15 microns, 20 microns, 25 microns, 30 microns, 35 microns, 40 microns, 45 microns, 50 microns, 55 microns, 60 microns, 65 microns, 70 microns, 75 microns, 80 microns, 85 microns, 90 microns, 95 microns, or 100 microns, including any value and range therebetween.

In some embodiments, the composition and/or polymer of the invention is characterized by one or more specific properties. In some embodiments, the term “property”, or any grammatical derivative thereof, refers to properly of the surface. In some embodiments, the term “property” refers to desired permeability. In some embodiments, the term property refers to wettability. In some embodiments, the term “property” refers to adhesive affinity to the plant surface. In some embodiments, the term “property” refers to hydrophobicity. In some embodiments, the term “property” refers to biocompatibility of the composition and/or polymer. By “biocompatibility” it is meant that the composition will sustain the growth of living plant tissue.

In some embodiments, the term “property” refers to dirt and dirt resistance.

In some embodiments, the term “property” refers to mechanical performance of the polymer, e.g., its being film forming polymer.

In some embodiments, the mechanical performance relates to flexibility.

In some embodiments, the term “property” refers the surface energy of the polymeric composition. As used herein and in the art, the term “surface energy” is the energy associated with the intermolecular forces at the interface between two media (e.g., surface and surrounding air). In some embodiments, the surface energy per unit area (also termed “surface free energy”) equals the surface tension.

The surface free energy (SFE) of the pepper fruit plant was found to be 30-36 mJ/m² (see: Front. Plant Sci. 2015; 6:510) which is a median value between hydrophobic and hydrophilic surfaces.

Without being bound by any particular theory, it is assumed that in order for a plastic film to adhere to a plant stalk, the film's SFE should be approximately (e.g., up to ±30%) equal to that of the stalk. Hydrophobic films with SFE much below this value will be repulsed or rejected by the plant stalk.

In some embodiments, the polymeric composition is characterized by a surface free energy that ranges from 20 to 70 mJ/m², 20 to 30 mJ/m², 20 to 40 mJ/m². For example, the disclosed polymeric composition is characterized by a surface free energy of e.g., 20 mJ/m², 25 mJ/m², 30 mJ/m², 35 mJ/m², 40 mJ/m², 45 mJ/m², 50 mJ/m², 55 mJ/m², 60 mJ/m², 65 mJ/m², or 70 mJ/m², including any value and range therebetween.

In some embodiments, the polymeric composition is substantially devoid of cracking defects. As used herein, the term “cracking defects” refers to cracks that are at least observable with the naked eye within and/or at the surface of the polymeric composition.

Therefore, typically, but not exclusively, the composition comprising the polymer and optionally the plasticizer is characterized by a sufficiently flexible so as to be wound around e.g., 1-5 mm, 5-10 mm, 10-20 mm, 20-50 mm, or 50-100 mm, plant structure (e.g., stalk) without fracture or break. Methods for assessing the flexibility at break are known in the art (see e.g., ASTM. F137-08(2013).

In some embodiments, the composition is substantially devoid of water. In some embodiments, by “substantially devoid of water” it is meant that the composition comprises less than 5% of water, by (total) weight. In some embodiments, by “substantially devoid of water” it is meant that the composition comprises less than 4% of water, by (total) weight. In some embodiments, by “substantially devoid of water” it is meant that the composition comprises less than 3% of water, by (total) weight. In some embodiments, by “substantially devoid of water” it is meant that the composition comprises less than 2% of water, by (total) weight. In some embodiments, by “substantially devoid of water” it is meant that the composition comprises less than 1% of water, by (total) weight. In some embodiments, by “substantially devoid of water” it is meant that the composition comprises less than 0.5% of water, by (total) weight. In some embodiments, by “substantially devoid of water” it is meant that the composition comprises less than 0.1% of water, by (total) weight.

In some embodiments, the polymer is selected from polyacryls and polyesters.

Non-limiting examples of polymers useful according to the invention are polyvinyl acetate (PVAc), polyvinyl alcohol (PVA), hydroxypropyl cellulose (HPC), hydroxy ethyl cellulose (HEC), and polyvinyl pyrrolidone (PVP), polyethylene glycol (PEG) and polyvinyl chloride (PVC). Any combinations of the different polymers in a single composition (e.g., formulation) are also encompassed by the invention.

Table 1 below provides the chemical structures of non-limiting exemplary polymeric compounds that may incorporate active agents (e.g., strigolactones as described below), for enhancing and prolonging their biological activity on the plant.

TABLE 1

| No. | Abbreviation | Chemical Name | Structure |
|---|---|---|---|
| 1 | PVAc | polyvinyl acetate | 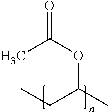 |
| 2 | HPC | hydroxypropyl cellulose | 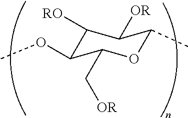 |
| | | | R = H or CH₂CH(OH)CH₃ |
| 3 | HEC | hydroxy ethyl cellulose | 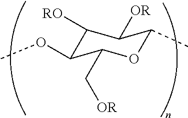 |
| | | | R = H or CH₂CH₂OH |
| 4 | PVP | polyvinyl pyrrolidone | 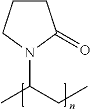 |
| 5 | PVA | polyvinyl alcohol | 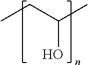 |

Further non-limiting examples of polymers include both hydrophobic and hydrophilic polymers. Non-limiting examples of hydrophobic polymers include, but are not limited to, ethyl cellulose and other cellulose derivatives, fats such as glycerol palmito-stereate, polymethylmethacrylate, beeswax, glycowax, castorwax, carnaubawax, glycerol monostereate or stearyl alcohol, hydrophobic polyacrylamide derivatives and hydrophobic methacrylic acid derivatives, as well as mixtures of these polymers.

In some embodiments, the polymer (e.g., PEG) is characterized by a weight average molecular weight (Mw; in grams/mole) of at least e.g., 10,000, 20,000, 30,000, 40,000, 50,000, 60,000, 70,000, 80,000, 90,000, 100,000, 200,000, 100,000, 200,000, 300,000, 400,000, 500,000, 600,000, 700,000, 800,000, 900,000, or 1,000,000, including any range therebetween.

In some embodiments, the term “weight average molecular weight” generally refers to a molecular weight measurement that depends on the contributions of polymer molecules according to their sizes.

Hydrophilic polymers include, but are not limited to, hydrophilic cellulose derivatives such as methyl cellulose, hydroxypropylmethyl cellulose, hydroxyethyl cellulose, hydroxypropyl cellulose, carboxymethyl cellulose, sodium carboxymethyl cellulose and hydroxyethyl methyl-cellulose polyvinyl alcohol, polyethylene, polypropylene, polystyrene, polyacrylamide, ethylene vinyl acetate copolymer, poly-urethane, polyvinylpyrrolidone, polyvinyl acetate, polyacrylamide, polymethacrylic acid, as well as mixtures of these polymers. Furthermore, any mixture of one or more hydrophobic polymer and one or more hydrophilic polymer may optionally be used.

One of the criteria for selection of the various units of the polymer as presented herein, exhibiting suitable functionalities in accordance to the requirement. For example, the disclosed composition may comprise one or more water-sensitive reagents (agents).

Depending on the agent desired to be attached to the polymer, the polymeric composition's properties can be pre-determined so as to allow the formation of the desired interactions between the agent and the polymer.

In some embodiments, these properties can be determined by virtue of the side chains of the polymer by virtue of the polymer backbone, or by virtue of an additive being incorporated within the polymer.

In some embodiments, for attaching an agent via hydrophobic interactions, polymeric composition comprising hydrophobic additive are prepared.

In some embodiments, for attaching a chiral agent, optically active polymers having a complementary stereoselectivity may be used.

The Additive

Accordingly, the composition according to the present invention may further comprise at least one additional component, also referred to herein as “additive”.

The terms “additive”, “plasticizer”, “stabilizer” and “carrier” are used hereinthroughout interchangeably.

According to some embodiments of the invention, the additive is a hydrophobic compound which plasticizes the polymer. In some embodiments, the composition comprises a hydrophilic polymer or a hydrophilic additive. According to some embodiments of the invention, the additive is a hydrophilic compound which plasticizes the polymer.

In some embodiments, the terms “stabilizing compound”, or “additive” as used herein refer to a natural or synthetic material that is combined with the active agent of the invention, e.g., to increase its durability and to increase its penetration to the plant.

According to still an additional aspect of the present invention there is provided a composition comprising a polymer, as described herein, having attached to or incorporated thereto an additive and an active agent.

The additive may allow to achieve higher mobility of active agent(s) to the outer surface of the composition. The mobility, in some embodiments, depends on the morphology of the polymer e.g., presence of defects, chain conformation or one of the properties described hereinabove.

In some embodiments, the term “mobility” refers to the solubility of the active agent(s) in the additive. As used herein, the term “solubility” refers to the ability of the active agents of the present invention to dissolve without substantial aggregation.

In some embodiments, the carrier compound increases the stability of the natural or synthetic hormone, thereby supporting its effective application to the plant.

In some embodiments, the composition imparts long-lasting and stable medium for preserving the active agent.

As used hereinthroughout, the term “stable”, or any grammatical derivative thereof, may refer to chemical stability. In some embodiments, the term “chemical stability” means that an acceptable percentage of degradation of the active agent (e.g., plant hormone) structure disclosed hereinthroughout by chemical pathways such as oxidation or hydrolysis is formed. In particular, the active agent is considered chemically stable if no more than e.g., about 30%, or about 20% breakdown products are formed after e.g., two weeks of storage at the intended storage temperature of the product (e.g., at room temperature, i.e. 15° C. to 40° C.).

In some embodiments, the term “stable” refers to biological stability. “Biological stability” as used herein means that the active ingredients maintain their biological activity.

In a specific embodiment, the strigolactones or strigolactone analogs and the formulations comprising them, are stable for at least 2 to 6 weeks and up to at least one year.

In some embodiments, the stabilizing compound is basically inert, and serves as a medium for maintaining the biological activity of e.g., the plant hormones by extending their half-life and durability.

Further to the active agent, and optionally the carrier, the compositions the invention may also comprise another plasticizing agent which serves as a solidifying substance. The plasticizer compound included in the formulation may be selected depending, inter alia, on the specific properties of the plant hormone presents in the polymeric mixture.

Table 2 below lists non-limiting examples of hydrophilic and hydrophobic plasticizers, useful according to the invention.

TABLE 2

| Hydrophilic | Hydrophobic |
|---|---|
| Glycerin | Acetyl Tributyl Citrate |
| Polyethylene Glycols | Acetyl Triethyl Citrate |
| Polyethylene Glycol Monomethyl Ether | Castor Oil |
| Propylene Glycol | Diacetylated Monoglycerides |
| Sorbitol Sorbitan Solution | Dibutyl Sebacate |
| | Diethyl Phthalate |
| | Triacetin |
| | Tributyl Citrate |
| | Triethyl Citrate |

In some embodiments, the additive is a low Mw polymeric compound (e.g., PEG).

In some embodiments, low Mw polymeric compound is characterized by a molecular weight (Mw; grams/mole) of less than e.g., 10,000, 5,000, 4,000, 3,000, 1,000, 900, 800, 700, 600, 500, 400, 300, 200, 100, including any range therebetween.

In some embodiments, the composition comprises PVC and PEG (e.g., PEG 600, i.e. having Mw of 600 gr/mole). In some embodiments, the composition comprises PVC and e.g., 1%, 5%, 10%, 15%, 20%, 25%, 30%, 35%, 40%, 45%, 50%, 55%, or 60% PEG, by weight, including any value and range therebetween. In some embodiments, the composition comprises PVC and e.g., 40% to 60% PEG, by weight, including any value therebetween.

In some embodiments, the polymer(s), additive(s) and the active agent(s) are attached to each other in a non-covalent manner. By “non-covalent manner” it is meant to refer to binding, by any non-covalent interaction, to another molecule, ion, complex or substance. The non-covalent interactions include, but are not limited to, ionotropic interaction, complexation interaction, electrostatic interactions, hydrogen bonds, receptor-substrate interactions, or any other non-covalent crosslinking and combinations thereof.

According to a specific embodiment of the invention, the plasticizing compound is glycerin (also termed “glycerol”).

In some embodiments, the polymeric composition comprises polysaccharide. In exemplary embodiments, the polysaccharide is selected from amylose, amylopectin, or a mixture thereof. In some embodiments, the composition comprises amylose, amylopectin or a derivative thereof and glycerin. In some embodiments, the composition comprises cellulose or a derivative thereof (e.g., HPC) and glycerin.

In some embodiments, the composition comprises e.g., 1%, 5%, 10%, 15%, 20%, 25%, 30%, 35%, 40%, 45%, 50%, 55%, 60% glycerol, by total weight, including any value and range therebetween. In some embodiments, the composition comprises e.g., 30% to 40% glycerol, by total weight. In some embodiments, the composition comprises e.g., 40% to 50%, glycerol, by total weight. According to a specific embodiment, the composition comprises about 40% glycerol, by total weight.

One specific formulation according to another embodiment comprises HPC and glycerin together with an active agent such as plant hormone (e.g., strigolactone) as described hereinbelow. As described hereinbelow, this formulation may have a marked effect on plants grown under greenhouse conditions.

Another specific formulation according to some embodiments of the invention comprises an active agent (e.g., strigolactone such as EGO10) together with PVAc.

The concentration of the active agent to be effective biological control agents may vary depending on the end use, physiological condition of the plant.

In some embodiments, the concentration of the active agent in the composition of the invention (e.g., strigolactone such as EGO10) is 1 μM, 2 μM, 3 μM, 4 μM, 5 μM, 6 μM, 7 μM, 8 μM, 9 μM, 10 μM, 11 μM, 15 μM, 20 μM, 25 μM, 30 μM, 35 μM, 40 μM, 50 μM, 60 μM, 70 μM, 80 μM, 90 μM, 100 μM, 150 μM, 200 μM, 250 μM, 300 μM, 350 μM, 400 μM, 450 μM, or 500 μM, including any value and range therebetween. In some embodiments, the concentration of the active agent in the composition of the invention range from 10 μM to 100 μM.

In some embodiments, the concentration of the active agent in the composition is (in ppm or mg/L) 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, including any value and range therebetween.

In some embodiments, the present invention provides a composition comprising strigolactone or a derivative thereof wherein a portion of the active agent (e.g., strigolactone or its derivative) is formulated for sustained and/or controlled release and a portion of the active agent (e.g., strigolactone or its derivative) is formulated for immediate release when contacting the plant.

In some embodiments, effective levels of the active agent diffused into the plant are achieved within from about 10 minutes to about 20 or 30 or 40 or 50 or 60, 90 minutes, 2 h, 3 h, 4 h, 5 h, 6 h, 7 h, 8 h, 9 h, 10 h following contacting the composition with the plant.

In some embodiments, effective levels of the active agent diffused into the plant are achieved within from about 1 day, two days, 3 days, 5 days, 10 days, 20 days, 30 days, 40 days, 50 days, 60 days, including any value therebetween.

In some embodiments, the compositions used by the invention may be formulated to release up to 5, 10, 15, 20, 25, 30, 35, 40, 45, 50, 55, 60, 65, 70, 75, 80, 85, 90, 95, 99, 99.5 or 100% of the total active agent (e.g., strigolactone or its derivative) in about 0.5, 1, 2, 3, 4, 5, 6, 7 or 8 hours.

Delivery Device

According to some embodiments, the present invention provides an article comprising the disclosed composition.

In some embodiments there is provided an article for the application of plant hormone formulations to a plant.

According to some embodiments, the article is a delivery device e.g., for the application of plant hormones to a plant. The delivery device may be adapted for installation on a part of a plant, thereby enabling the application of a plant hormone formulation to the plant.

According to one embodiment of the invention, the plant hormone formulation provided by the delivery device is filled after the installation of the device on the part of the plant. According to another embodiment, the delivery device is filled with the plant hormone formulation prior to the fasten of the device on the plant.

The delivery device of the invention, also termed “collar” or “ring”, is, in some embodiment, a container, a case, or a cover, in any suitable form, configured to wrap the part of the plant.

The delivery device may be capable of containing the formulations of the invention, and may enable the long-term application of the plant hormone to a specific locus on the treated plant.

The delivery device may comprise one or more polymers (in some embodiments, in addition to the polymeric composition) used to produce the delivery device. Non-limiting examples of the polymer used to produce the delivery device are corn starch, potato starch, agar, gelatin, PLA (polylactic acid) and PLGA (poly(lactic-co-glycolic acid)).

Non-limiting examples of suitable forms of the delivery device are a cylindrical form, a tube form, a ring form or a clamp form. In some embodiments, the delivery device according to the invention is made of a rigid, semi-rigid or flexible material, or any combinations thereof.

According to one embodiment, the delivery device is made of a biodegradable polymer, composed of pure or blends of bio-plastics with different plasticizers, selected from, but are not limited to, the list in Table 2 above. The term “pure” as used herein refers to one kind of polymer, and the term “blend” refers to a mixture of two or more polymers in different ratios.

According to a one embodiment of the invention, the delivery device is a paraffin film, also referred to herein as “parafilm”, which is used to wrap the composition according to the invention that is placed at a specific locus on the treated plant.

According to a another embodiment of the invention, the delivery device is a flexible plastic tube, that is threaded on the part of the plant, (e.g., on the stem or bark of the plant), and fixed on the desired locus by a transparent adhesive tape. After the installation of the plastic tube on the plant, it is filled with the formulation of the invention, and optionally sealed from both ends by cotton to prevent the leakage of the formulation and to minimize water evaporation.

According to a further embodiment of the invention, the delivery device is a rigid plastic tube, such as an Eppendorf tube. In some embodiments, the tube is cut from top to bottom and placed on the part of the treated plant (i.e., the stem). The tube is then sealed with a small moist cotton at the bottom, filled with the formulation of the invention, and finally covered with a transparent adhesive tape.

In some embodiments, delivery device for an active agent to a plant is made from the disclosed polymeric composition.

In some embodiments, the delivery system used by this invention may be administered in controlled release formulations. For example, in some embodiments, the strigolactone or derivative thereof may be formulated for immediate release upon contacting the plant. In some embodiments, the delivery device may be formulated for sustained and/or controlled release, and may optionally be formulated to have both immediate release and sustained and/or controlled release characteristics upon contacting the plant.

In some embodiments, the active agent (e.g., strigolactone or its derivative) in a composition used by the invention may be formulated to release not less than 5, 10, 15, 20, 25, 30, 35, 40, 45, 50, 55, 60, 65, 70, 75, 80, 85, 90, 95, 99, 99.5 or 100% of the total active agent (e.g., strigolactone or its derivative) in about 0.5, 1, 2, 3, 4, 5, 6, 7 or 8 hours, including any value therebetween.

In some embodiments, the polymeric composition is used to sustain or control the release of active agent (e.g., strigolactone or its derivative). In certain embodiments, the type of polymeric material and the amount of which is used, has a strong influence on the rate of release of active agent (e.g., strigolactone or its derivative) from the product of the present invention.

The delivery device according to the invention is adapted to be implemented on the part of the treated plant (i.e., the stem or the bark) for any period of time. The application period of the formulations by the delivery device may diverge according to the species and growth stage of treated plant, and with respect to the specific desire of the cultivator.

According to one embodiment of the invention, the delivery device is maintained on the plant for any time between one hour and 100 days. According to another embodiment of the invention, the delivery device is maintained on the plant for between four days and 20 days. According to a specific embodiment of the invention, the delivery device is maintained on the plant for 12 days.

The delivery device and the plant hormone formulation of the invention may be applied at any stage of the plants growth, starting from the first stage of growth in the greenhouse or nursery after the rooting of the seedling, after the hardening of the stem and throughout the entire life time of the mature plant.

Typically, but not exclusively, the delivery device is designed for a single use, and is removed (actively or spontaneity) from the plant after the plant hormone formulation is almost or completely absorbed by the plant. Optionally, once the amount of the formulation comprised in the delivery device decreases, the cultivator can refill the delivery device with an additional amount of the formulation, or remove the empty device and apply another full delivery device onto the plant.

In some embodiments, the delivery device is implemented on any part of the plant, for example, on the stem, on the bud, on root stock, on trunk, stalk or any part of the shoot.

Plant Hormones

In some embodiments, the active agent is a signaling molecule. In some embodiments, the signaling molecule is a plant signaling molecule. In some embodiments, plant signaling molecules refer to molecules that stimulate e.g., cell differentiation, fruit ripening, plant cell elongation, stem elongation and onset of dormancy.

In some embodiments, the active agent is hydrophobic.

In some embodiments, the plant signaling molecule is a plant hormone, e.g., a hydrophobic plant hormone. The term “plant hormone” as used herein refers to plant growth regulators. Non-limiting examples of plant hormones suitable for application according to the invention are auxin (for regulation of root development), cytokinin (for regulation of shoot branching), gibberellins (for regulation of shoot elongation), and any functional derivatives and analogs thereof.

According to a specific aspect of the invention, the plant hormone is strigolactone, a strigolactone analog, or any functional derivative thereof. It is noted that “strigolactones” as used herein, includes, in some embodiments, all forms of natural strigolactones, including, their pre-form, prodrugs, derivatives, recombinants, or any acceptable form thereof.

In some embodiments, by “active agent” it is meant to refer to two or more active agents. In exemplary embodiments, the active agent comprises strigolactone (e.g., EG10) and auxin.

It is noted that “strigolactone analogs” as used herein, includes, in some embodiments, all forms of strigolactones, including, their pre-form, prodrugs, derivatives, recombinants, or any acceptable form thereof which have activity similar to native strigolactones.

In one embodiment, the plant hormone is a compound of formula I:

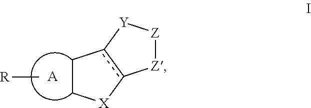

wherein:
A is an aromatic or non-aromatic 5, 6, or 7 carbon atom membered ring;
X is CH₂, NH, or NR′;
Y is CH₂ or O;
Z is CO or -(4-methyl-5-oxo-2,5-dihydrofuran-2-yloxy)-methylene;
Z′ is CO or -(4-methyl-5-oxo-2,5-dihydrofuran-2-yloxy)-methylene;
R represents 1 to 5 substituents selected from hydrogen, aryl, heteroaryl, NH₂, NHR′, NR′₂, a fused ring, or alkyl;
R′ is aromatic or heteroaromatic ring or alkyl,

or a pharmaceutically acceptable salt thereof.

Accordingly, the present invention encompasses the use of natural strigolactone hormones.

In a specific embodiment of the invention, the natural strigolactone hormone is selected from the following:

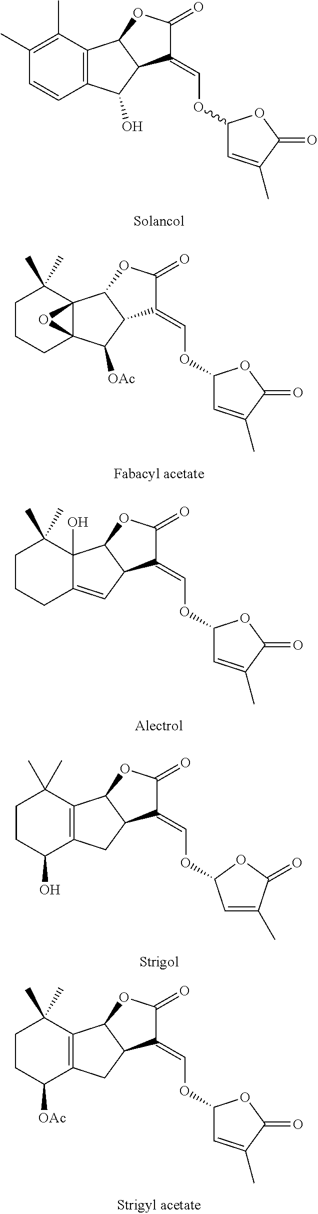

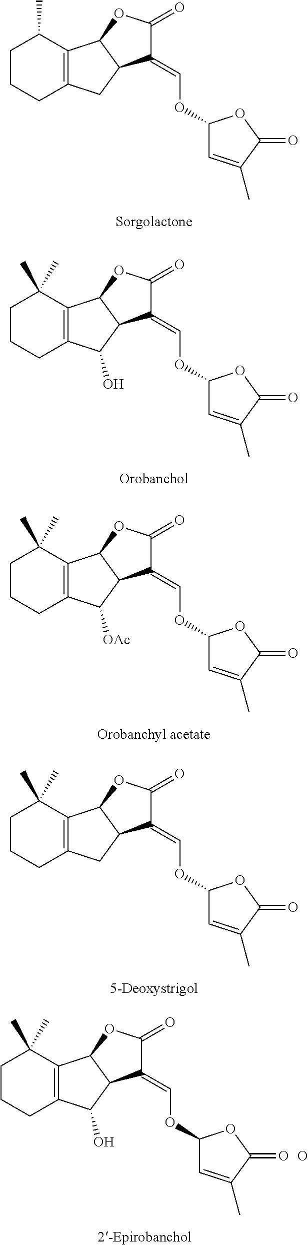

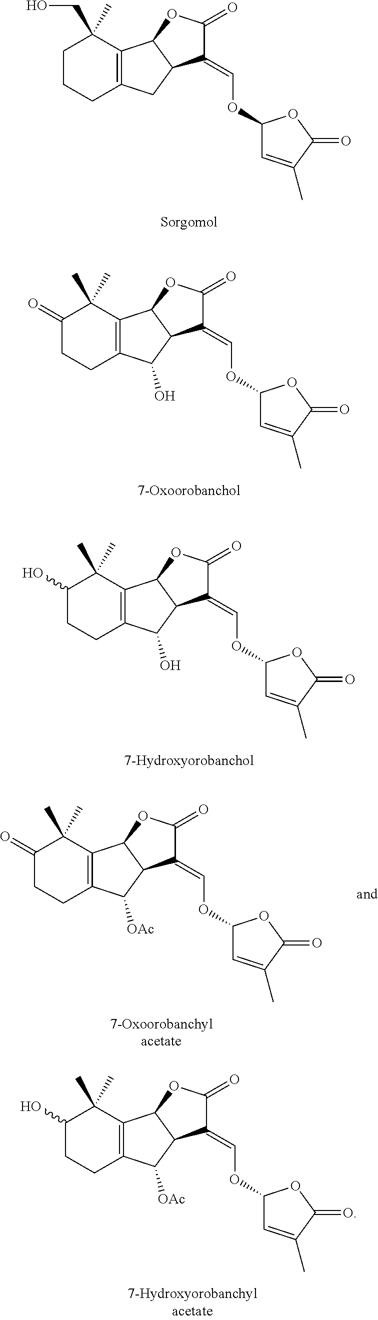

In another embodiment, the plant hormone the plant hormone is a compound of formula II:

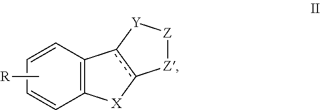

wherein
X is CH₂, NH, or NR′;
Y is CH₂ or O;
Z is CO or -(4-methyl-5-oxo-2,5-dihydrofuran-2-yloxy)-methylene;
Z′ is CO or -(4-methyl-5-oxo-2,5-dihydrofuran-2-yloxy)-methylene;
R represents 1 to 5 substituents selected from hydrogen, aryl, heteroaryl, NH₂, NHR′, NR′₂, or alkyl;

R′ is aromatic or heteroaromatic ring or alkyl;

or individual isomer, pharmaceutically acceptable salt thereof, or a mixture thereof

The examples to follow illustrate the beneficial effects of the compounds of formula II, referred to herein as “strigolactone analogs”.

The compounds of formula II may be present as mixtures of diastereoisomers or as a racemic mixture or as pure isomers, optionally as enantio-pure isomers, that is, individual isomers or mixture of isomers thereof.

Table 3 below lists examples of strigolactone analogs useful according to the present invention, together with their chemical names and given codes.

TABLE 3

| No. | Chemical Name | Code |
|---|---|---|
| 1 | (3aR*,8bS*,E)-3-(((R*)-4-methyl- | GR-24 |
| | 5-oxo-2,5-dihydrofuran-2-yloxy)- | |
| | methylene)-3,3a,4,8b-tetrahydro-2H- | |
| | indeno[1,2-b]furan-2-one | |
| 2 | (±) (2E)-4-methyl-2-(4-methyl- | EG-5 |
| | 5-oxo-2,5-dihydrofuran-2- | |
| | yloxymethylene)-1,4-dihydro-2H- | |
| | cyclopenta[b]indol-3-one | |
| 3 | (±) (2E)-7-bromo-4-methyl-2- | EG-7 |
| | (4-methyl-5-oxo-2,5-dihydrofuran-2- | |
| | yloxymethylene)-1,4-dihydro-2H- | |
| | cyclopenta[b]indol-3-one | |
| 4 | (±) (2E)-4-methyl-2-(4- | EG-9a |
| | methyl-5-oxo-2,5-dihydrofuran-2- | |
| | yloxymethylene)-7-(4-nitrophenyl)-1,4- | |
| | dihydro-2H-cyclopenta[b]indol- | |
| | 3-one | |
| 5 | (±) (2E)-4-methyl-2-(4- | EG-9b |
| | methyl-5-oxo-2,5-dihydrofuran-2- | |
| | yloxymethylene)-7-(2-thienyl)- | |
| | 1,4-dihydro-2H-cyclopenta[b]indol-3- | |
| | one | |
| 6 | (±) (2E)-4-methyl-2-(4- | EG-9c |
| | methyl-5-oxo-2,5-dihydrofuran-2- | |
| | yloxymethylene)-7-[(4- | |
| | dimethylamino)-phenyl]-1,4-dihydro-2H- | |
| | cyclopenta[b]indol-3-one | |
| 7 | (2E)-7-(1-methoxynaphthalen-2-yl)- | ST-23a |
| | 1,4-dimethyl-2-((4-methyl-5-oxo- | |
| | 2,5-dihydrofuran-2-yloxy)methylene)- | |
| | 1,2-dihydrocyclopenta[b]indol- | |
| | 3(4H)-one | |
| 8 | (2E)-2-[(2,5-dihydro-4-methyl-5- | ST-23b |
| | oxofuran-2-yloxy)methylene]-1,2- | |
| | dihydro-7-[4-(dimethylamino)pheny]- | |
| | 1,4-dimethyl-cyclopenta[b]indole-3-(4H)-one | |
| 9 | (2E)-1,4-dimethyl-2-((4-methyl-5- | ST-357 |
| | oxo-2,5-dihydrofuran-2-yloxy) | |
| | methylene)-7-(thiophen-2-yl)-1,2- | |
| | dihydrocyclopenta[b]indol-3(4H)-one | |
| 10 | (2E)-2-[(2,5-dihydro-4-methyl- | ST-362 |
| | 5-oxofuran-2-yloxy)methylene]-1,2- | |
| | dihydro-7-(2,3-dihydrothieno[3,4- | |
| | b][1,4]dioxin-7-yl)-1,4-dimethyl- | |
| | cyclopenta[b]indole-3-(4H)-one | |
| 11 | (±) 2E-4-methyl-2-(4-methyl- | MEB-55 |
| | 5-oxo-2,5-dihydrofuran-2- | |
| | yloxymethylene)-6-thiophen-2-yl-1,4- | |
| | dihydro-2H-cyclopenta[b]indol- | |
| | 3-one | |

According to a specific embodiment of the invention, the compound of formula II is selected from EGO10, GR24, and ST362, e.g., having the following formulae:

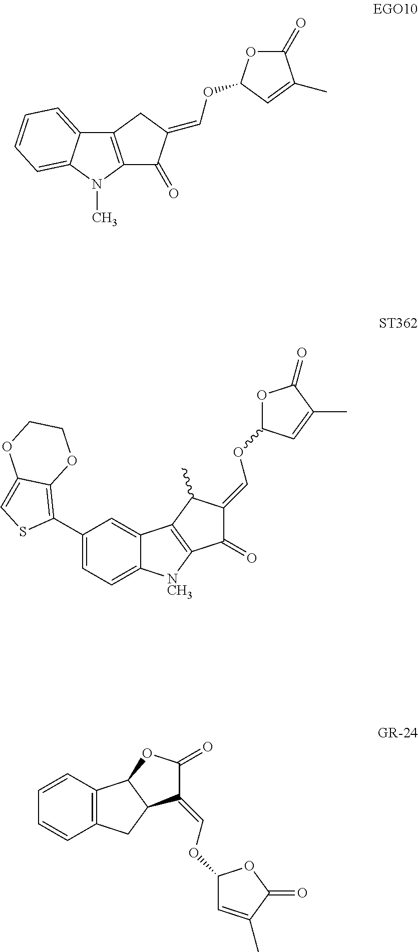 [SMILES: CC1=C[C@H](O/C=C2\Cc3c(n(C)c4ccccc34)C2=O)OC1=O ; CC1=CC(O/C=C2/C(=O)c3c(c4cc(-c5scc6c5OCCO6)ccc4n3C)C2C)OC1=O ; CC1=C[C@H](O/C=C2/C(=O)O[C@@H]3c4ccccc4C[C@H]23)OC1=O]

The plant hormone formulations according to the invention, also referred to herein as the “polymeric composition”, include at least one plant hormone or any synthetic analog thereof (i.e., a natural strigolactone or a strigolactone analog), as the active agent, a compound that serves as the medium, and optionally a plasticizing agent.

As described hereinabove, in some embodiments, the formulations are provided to the plant via a delivery device as described hereinabove.

In some embodiments, the formulations according to the invention further comprises additional solid or liquid materials in accordance with the general formulation techniques acceptable in the field.

In some embodiments, the active strigolactone compound and the medium compound present in the compositions according to the invention are applied to the plant in any ratio between the two.

In some embodiments, compositions comprising a plasticizer, such as a formulation comprising EGO10, HPC and glycerin, are applied to the plant in any ratio between the three.

Method for Applying a Plant Hormone

According to another aspect, there is provided a method for applying an active agent (e.g., a plant hormone) to a plant, the method comprising providing the article or composition described herein to a plant. In one embodiment, the providing the composition is contacting the plant with the delivery device of the invention, the delivery device comprises the composition of the invention.

In another aspect, the present invention provides a method for applying a plant hormone formulation to a plant. In some embodiments, the method comprises

In some embodiments, the method comprises providing a delivery device adapted to contain a plant hormone formulation (i.e. the hereinabove disclosed composition), and installing the delivery device on a part of the plant.

In some embodiments, the plant hormone formulation is provided prior to or after the installation of the device on the plant. According to a specific embodiment, the plant hormone formulation is provided in the delivery device prior to its fastening on the plant, and refilled after a desired period of time. In another embodiment, the method includes the step of sealing the delivery device, containing the plant hormone formulation, optionally by a piece of tape.

The plant hormone applied according to the method of the invention may be any plant growth regulator and/or plant hormone, selected for example, from auxin, cytokinin, gibberellin, strigolactone, and any analog thereof.

In some embodiments, the method is specifically suitable for the application of a strigolactone, a strigolactone derivative or a strigolactone analog to a plant, for decreasing or preventing axillary bud growth.

According to one embodiment of the invention, the formulation provided to the plant by the delivery device is a strigolactone, a strigolactone derivative or a strigolactone analog together with a medium compound. According to another embodiment of the invention, the formulation further comprises a plasticizing agent (plasticizer) as described hereinabove.

According to a specific embodiment, the strigolactone or strigolactone analog is selected from EGO10, GR24, and ST362, the composition comprises a compound is selected from polyvinyl acetate (PVAc), polyvinyl alcohol (PVA), hydroxypropyl cellulose (HPC), hydroxy ethyl cellulose (HEC), polyvinyl pyrrolidone (PVP), or any combinations thereof, and the plasticizing agent is glycerin.

In some embodiments, plants that can be treated with natural or synthetic strigolactone formulations according to the present invention include any plant that can benefit from enhancing its epical dominancy, including woody plants such as fruit trees and ornamental plants, non-woody plants such as vegetables and herbs. Non-limiting examples of plants suitable for the practice of the present invention are olives, Hypericum, roses, tomatoes, pepper, and grapes.

In some embodiments, the formulations according to the present invention comprising a strigolactone or strigolactone analog in a polymeric compound (and optionally at least one plasticizing agent as described herein) may further comprise additional pharmaceutically accepted additives or excipients.

The additives or excipients assist the penetration of the active agent to the plant, preserve the active agent and inhibit its degradation. These activities prolong the biological activity and increase the efficacy of the compounds of the invention. Excipients that can be employed include any excipients known in the art for the preparation of formulations.

In some embodiments, the composition according to the invention is non-toxic and harmless to both the plant and the environment.

According to another aspect, the present invention provides an easy and cost effective method for designing the architecture of a plant by enhancing its apical dominancy, and suppressing axillary bud (e.g., wake-up bud) growth, thereby preventing the development of non-desired axillary branches.

Consequently, the method of the invention dramatically reduces the time and labor required during the entire growth period of the plant, and enhances the yield, growth or vigor of the treated plant, thus increases the profitability of the crop.

In another aspect, the invention provides a method for decreasing or preventing axillary bud growth in a plant, characterized in that a delivery device comprising at least one strigolactone, strigolactone derivative or strigolactone analog compound, optionally in combination with at least one plasticizer agent, is applied to a plant.

Accordingly, in some embodiments, the method of the invention mainly consists of contacting one or more of the formulations of the invention to the plant via a delivery device.

The term “wake-up bud” as used herein refers to axillary buds that are in the process of growing.

### Definitions

As used herein, the term “alkyl” describes an aliphatic hydrocarbon including straight chain and branched chain groups. Preferably, the alkyl group has 21 to 100 carbon atoms, and more preferably 21-50 carbon atoms. Whenever a numerical range; e.g., “21-100”, is stated herein, it implies that the group, in this case the alkyl group, may contain 21 carbon atom, 22 carbon atoms, 23 carbon atoms, etc., up to and including 100 carbon atoms. In the context of the present invention, a “long alkyl” is an alkyl having at least 20 carbon atoms in its main chain (the longest path of continuous covalently attached atoms). A short alkyl therefore has 20 or less main-chain carbons. The alkyl can be substituted or unsubstituted, as defined herein

The term “alkyl”, as used herein, also encompasses saturated or unsaturated hydrocarbon, hence this term further encompasses alkenyl and alkynyl.

The term “alkenyl” describes an unsaturated alkyl, as defined herein, having at least two carbon atoms and at least one carbon-carbon double bond. The alkenyl may be substituted or unsubstituted by one or more substituents, as described hereinabove.

The term “alkynyl”, as defined herein, is an unsaturated alkyl having at least two carbon atoms and at least one carbon-carbon triple bond. The alkynyl may be substituted or unsubstituted by one or more substituents, as described hereinabove.

The term “cycloalkyl” describes an all-carbon monocyclic or fused ring (i.e. rings which share an adjacent pair of carbon atoms) group where one or more of the rings does not have a completely conjugated pi-electron system. The cycloalkyl group may be substituted or unsubstituted, as indicated herein.

The term “aryl” describes an all-carbon monocyclic or fused-ring polycyclic (i.e., rings which share adjacent pairs of carbon atoms) groups having a completely conjugated pi-electron system. The aryl group may be substituted or unsubstituted, as indicated herein.

The term “alkoxy” describes both an —O-alkyl and an —O-cycloalkyl group, as defined herein.

The term “aryloxy” describes an —O-aryl, as defined herein.

Each of the alkyl, cycloalkyl and aryl groups in the general formulas herein may be substituted by one or more substituents, whereby each substituent group can independently be, for example, halide, alkyl, alkoxy, cycloalkyl, alkoxy, nitro, amine, hydroxyl, thiol, thioalkoxy, thiohydroxy, carboxy, amide, aryl and aryloxy, depending on the substituted group and its position in the molecule. Additional substituents are also contemplated

The term “halide”, “halogen” or “halo” describes fluorine, chlorine, bromine or iodine.

The term “haloalkyl” describes an alkyl group as defined herein, further substituted by one or more halide(s).

The term “haloalkoxy” describes an alkoxy group as defined herein, further substituted by one or more halide(s).

The term “hydroxyl” or “hydroxy” describes a —OH group.

The term “thiohydroxy” or “thiol” describes a —SH group.

The term “thioalkoxy” describes both an —S-alkyl group, and a —S-cycloalkyl group, as defined herein.

The term “thioaryloxy” describes both an —S-aryl and a —S-heteroaryl group, as defined herein.

The term “amine” describes a —NR′R″ group, with R′ and R″ as described herein.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine.

The term “heteroalicyclic” or “heterocyclyl” describes a monocyclic or fused ring group having in the ring(s) one or more atoms such as nitrogen, oxygen and sulfur. The rings may also have one or more double bonds. However, the rings do not have a completely conjugated pi-electron system. Representative examples are piperidine, piperazine, tetrahydrofurane, tetrahydropyrane, morpholino and the like.

The term “carboxy” or “carboxylate” describes a —C(═O)—OR′ group, where R′ is hydrogen, alkyl, cycloalkyl, alkenyl, aryl, heteroaryl (bonded through a ring carbon) or heteroalicyclic (bonded through a ring carbon) as defined herein.

The term “carbonyl” describes a —C(═O)—R′ group, where R′ is as defined hereinabove.

The above-terms also encompass thio-derivatives thereof (thiocarboxy and thiocarbonyl).

The term “thiocarbonyl” describes a —C(═S)—R′ group, where R′ is as defined hereinabove.

A “thiocarboxy” group describes a —C(═S)—OR′ group, where R′ is as defined herein.

A “sulfinyl” group describes an —S(═O)—R′ group, where R′ is as defined herein.

A “sulfonyl” or “sulfonate” group describes an —S(═O)₂—R′ group, where Rx is as defined herein.

A “carbamyl” or “carbamate” group describes an —OC(═O)—NR′R″ group, where R′ is as defined herein and R″ is as defined for R′.

A “nitro” group refers to a —NO₂ group.

A “cyano” or “nitrile” group refers to a —C≡N group.

As used herein, the term “azide” refers to a —N₃ group. The term “sulfonamide” refers to a —S(═O)₂—NR′R″ group, with R′ and R″ as defined herein.

The term “phosphonyl” or “phosphonate” describes an —O—P(═O)(OR′)₂ group, with R′ as defined hereinabove.

The term “phosphinyl” describes a —PR′R″ group, with R′ and R″ as defined hereinabove.

The term “alkaryl” describes an alkyl, as defined herein, which substituted by an aryl, as described herein. An exemplary alkaryl is benzyl.

The term “heteroaryl” describes a monocyclic or fused ring (i.e., rings which share an adjacent pair of atoms) group having in the ring(s) one or more atoms, such as, for example, nitrogen, oxygen and sulfur and, in addition, having a completely conjugated pi-electron system. Examples, without limitation, of heteroaryl groups include pyrrole, furane, thiophene, imidazole, oxazole, thiazole, pyrazole, pyridine, pyrimidine, quinoline, isoquinoline and purine. The heteroaryl group may be substituted or unsubstituted by one or more substituents, as described hereinabove. Representative examples are thiadiazole, pyridine, pyrrole, oxazole, indole, purine and the like.

As used herein, the terms “halo” and “halide”, which are referred to herein interchangeably, describe an atom of a halogen, that is fluorine, chlorine, bromine or iodine, also referred to herein as fluoride, chloride, bromide and iodide.

The term “haloalkyl” describes an alkyl group as defined above, further substituted by one or more halide(s).

General:

As used herein the term “about” refers to ±10%.

The terms “comprises”, “comprising”, “includes”, “including”, “having” and their conjugates mean “including but not limited to”. The term “consisting of means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

As used herein, the term “treating” includes abrogating, substantially inhibiting, slowing or reversing the progression of a condition, substantially ameliorating clinical or aesthetical symptoms of a condition or substantially preventing the appearance of clinical or aesthetical symptoms of a condition.

In those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

### Example 1: Application of Strigolactone Analogs by Irrigation

The effect of application of various analogues of strigolactone (SL) on olives, given to roots by irrigation was examined. Three different SL analogs; GR24, EGO10 and ST362 were applied at a concentration of 0 (control), 0.03 and 0.3 μM to olive seedlings during vegetative growth. The seedlings were rooted from cuttings and hardened, and were about 6 months old at the time of the experiment. Growth soil mixture was used as in the nursery. Each strigolactone analog was dissolved in acetone to give a 5.6 mM solution. This solution was then further diluted with distilled water to 0.03 and 0.3 μM. The diluted solution was injected to the roots twice a week for 6 weeks, and subsequently all the growing buds were counted. For each treatment (treated and control groups) 10 plants were measured. Experiments were repeated three times.

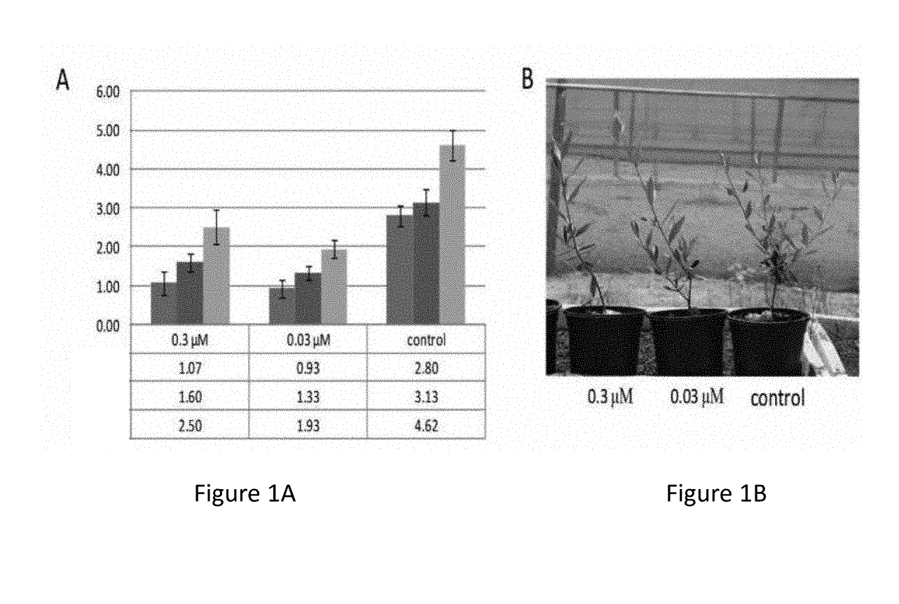

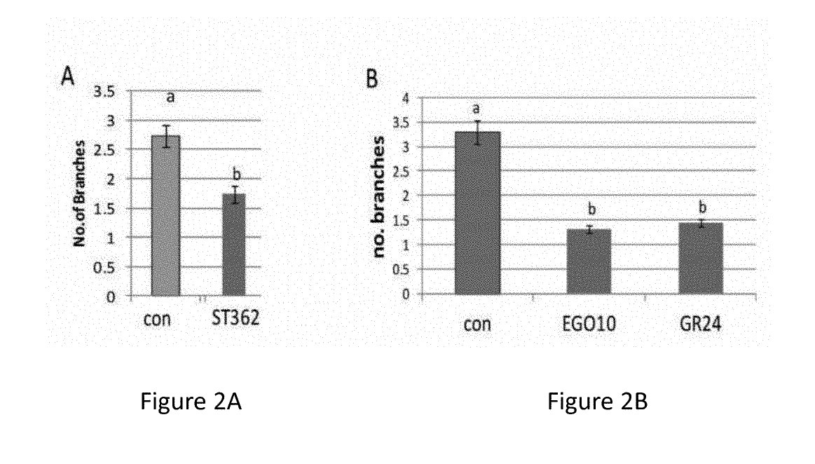

The results show that application of GR24 lead to a significant reduction in number of lateral branches. The effect was most prominent at a concentration of 0.03 μM (FIG. 1A and FIG. 1B). A similar, albeit less potent effect was evident upon the application of ST362 to plants (FIG. 2A), whereas EGO10 showed a repressing effect on axillary branch growth similar to that of GR24 (FIG. 2B).

### Example 2: Strigolactone Analogs Stability

The implementation of the strigolactone analogs necessitates a degree of material stability, to ensure their activity on the plant under various growth conditions. Accordingly, the stability of the strigolactone analog GR24 was tested under different environmental conditions. GR24 in acetone stock solution of 5.6 mM was diluted in double distilled water (DDW) or HPC pre-made gel to a concentration of 0.56 μM in eppendorf tubes and was subjected to the following treatments:

a. Temperature Range of 4 to 60° C. for Periods of 1 Hour to 7 d:

GR24 solutions of 0.56 μM, diluted either in DDW or in HPC pre-made gel in eppendorf tubes were incubated in a dry block heater at temperatures of 4° C., 20° C., 40° C., 60° C. digitally set for periods of 3 h, 1 d, 2 d, 4 d, 5 d and 7 d under ambient light.

b. UV Radiation:

GR24 solutions of 0.56 μM, diluted either in DDW or in HPC pre-made gel, each in quartz tubes (15 replicates for each treatment) were exposed to UV radiation of λ=312 nm under UV lamp of 600 or 857 μE intensity for periods of 15 min, 30 min or 18 h.

Biological activity was determined by Orobanche Germination Assay: Approximately 30 to 50 seeds of Orobanche aegyptiaca were spread on a glass fiber filter paper disk (9-mm diameter) and put into sterile petri dishes (9-cm diameter) lined with Whatman filter paper wetted with 3 mL of demineralized water. Petri dishes were sealed with parafilm and incubated at 27° C. for preconditioning. After one week of preconditioning period, the glass fiber filter paper disks with Orobanche seeds were removed from the petri dish and dried for 20 min to remove surplus moisture. The disks were transferred to another petri dish within a filter paper ring (outer diameter of 9 cm; inner diameter of 8 cm) wetted with 0.9 mL of water, which maintained a moist environment during the germination bioassay. Forty microliters of the GR24 test solutions were added to the disks. Untreated GR24 at a 0.56 μM concentration was used as a positive control, water or HPC pre-made gel as negative controls. Germination percent was calculated using the counter cell analysis of the IMAGEJ (http://www.//rsbweb.nih.gov/ij/) software. Germinated seeds were distinguished from non-germinated seeds according to the seedling radicles, which are a few millimeters long and visible under a stereomicroscope (Leica MZFLIII, Leica Microsystems, GmbH).

For each of the GR24 treatments fifteen replicates with 30-40 seeds were tested per treatment with 40 μl of 0.56 μM GR24 test solutions pre-treated as described above. The experiment was repeated three times (n=450 seeds).

Mass spectrometry (MS) analysis was performed to GR24 test solutions using the Orbitrap XL (Thermo Fisher Scientific). The samples were injected directly using direct spray injection probe, in 50% acetonitrile solution and at 5 ml/min flow rate. A full scan was acquired to detect the GR24 peaks, at 60,000 resolution, Maximum ion fill time settings were 300 ms for the high resolution full scan in the Orbitrap analyzer. The spectra are sum of 10 sec acquisition. Results observed by Xcalibur© software of Thermo Fisher Scientific Inc. version 2.0.7. were analyzed manually.

The results showed that GR24 loses biological activity and is molecularly degrading following long term exposure (over 5 days) to temperatures above 40° C., under acidic pH solutions and following exposure to UV irradiation.

Next, GR24 was stabilized with Hydroxypropyl Cellulose (HPC), which is a hydrophobic medium. Granular HPC [Sigma-Aldrich Israel Ltd., CAS-No. 9004-64-2] (1 g) was ground to a fine powder using a mortar and pestle, mixed with sterile distilled water to make about 10 mL of gel, and then allowed to stand for 1 day for complete dissolution at room temperature. Stability of GR24 was tested by both biological activity of the strigolactone and by assessing the molecule using LC-MS.

HPC medium stabilized GR24 by increasing its biological activity. The structure of the GR24 molecule remained intact under the examination conditions.

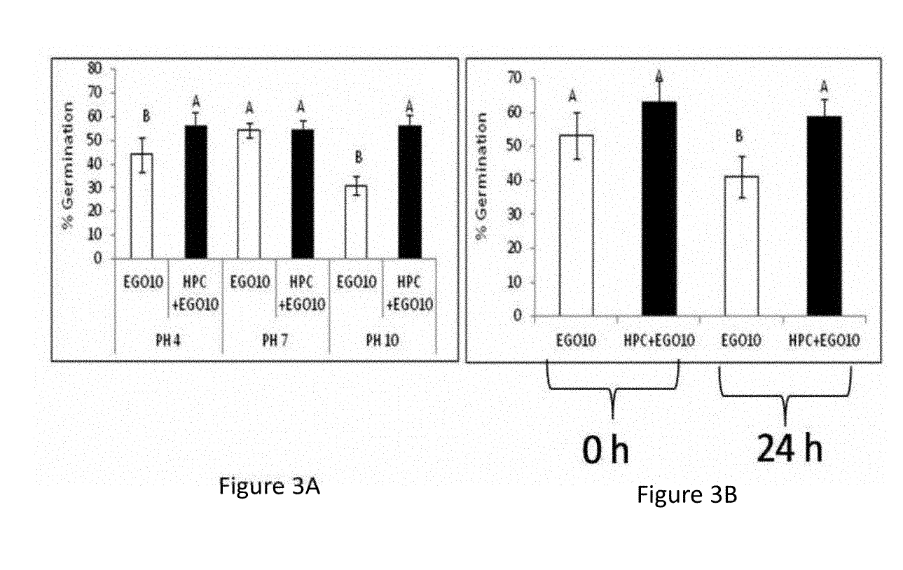

Further to the above, the stabilization effect of HPC on EGO10 at different pH conditions (pH 4, pH 7 and pH 10) and at a temperature of 60° C. was examined on Orobanche germination. The results demonstrate that HPC stabilizes EGO10, as evident by its increased biological activity, under basic and acidic pH conditions (FIG. 3A) and at 60° C. (FIG. 3B).

### Example 3: Application of Strigolactone Analogs Directly to Stems

Development of the Bioassay:

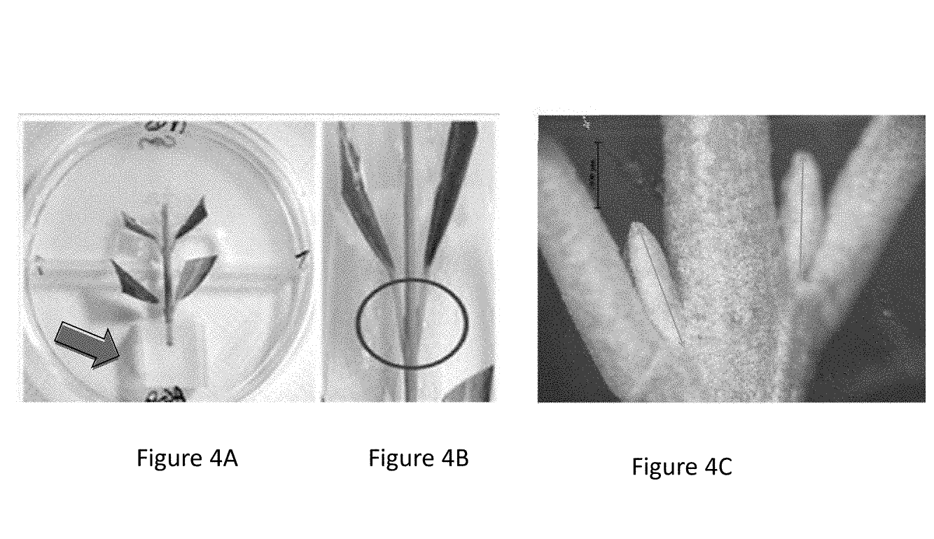

For the purpose of determining whether the active SL analogs may be used as effective repressors of shoot branching by application on the stem itself, a bioassay examining SL analogs effect on shoot branching in vitro was established. Olive seedlings were grown in greenhouse under controlled temperature of 23° C. Partitioned plates containing ½ Murashige and Skoog (MS) solidified with 1.5% w/v agar were prepared. After solidification, the center plastic area (2 cm) of the plate was removed by scalpel. Olive seedlings were cut between the second and fourth node, and the cuttings were surface-sterilized by 70% ethanol and 1% sodium hypochlorite treatment, and then placed on the plates containing the agar media. The SL analog EGO10 was mixed with ½MS in agar, cubes were cut (1.5 cm area) and positioned at the base of the cutting in the plates (FIG. 4A). Olive seedlings treated with acetone at the same concentrations used in the EGO10 treatments represented the experimental controls. Plates were sealed in two sides only by saran wrap in order to prevent accumulation of gases. The plates were positioned in an upright 90° position and incubated at 22° C. under a photoperiod of 16 hours light followed by 8 hours dark. Photographs were taken every 3 days until day 12 by binocular. Each treatment included eight replicates. FIG. 4B shows a node containing two buds. Bud outgrowth was measured (FIG. 4C) by Image J software and the length of the bud minus its length at the first day following application was calculated. Means of replicates were subjected to statistical analysis by using the IMP statistical package.

Effect of EGO10 Application at the Base of Plant Cuttings on Bud Outgrowth:

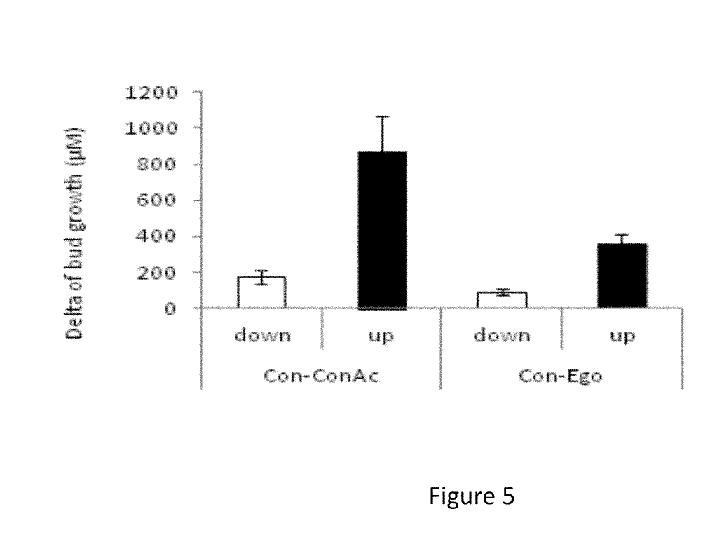

The effect of 5 μM EGO10, supplied in agar cubes at the base of olive seedling cuttings, on bud outgrowth was examined. At day 12, a marked reduction in bud outgrowth was observed compared to the control treatment (FIG. 5). These results indicate that the SL analogue EGO10 is an efficient inhibitor of olive bud outgrowth.

Effect of EGO10 Application at the Bark of Plant Cuttings on Bud Outgrowth:

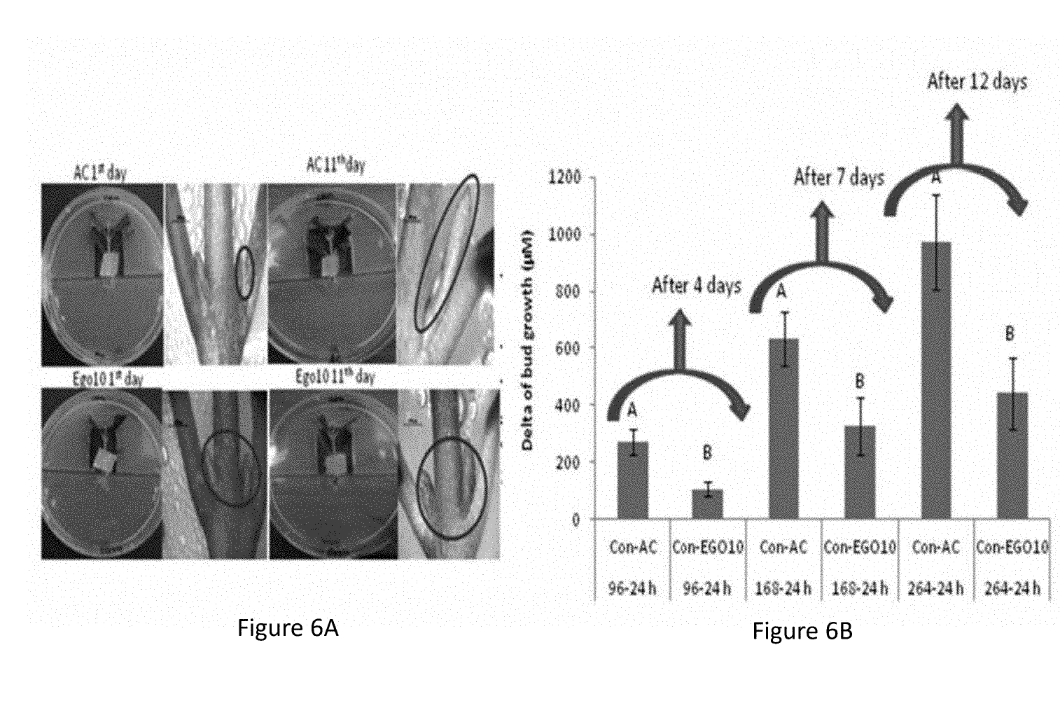

The ability of EGO10, applied to olive seedling cuttings through the bark of the stem, to reduce bud outgrowth was examined. An agar tube containing EGO10 was placed on the bark of the cutting (FIG. 6A). Additionally, for increased penetration of the hormone analog, the bark was scratched and the ability of EGO10 to reduce bud outgrowth in comparison to EGO10 application to non-scratched bark was tested.

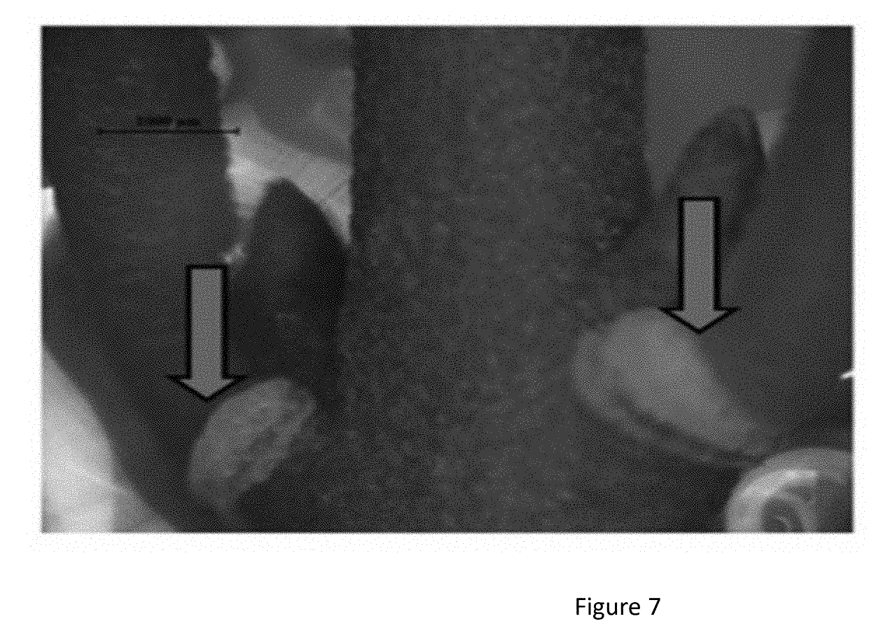

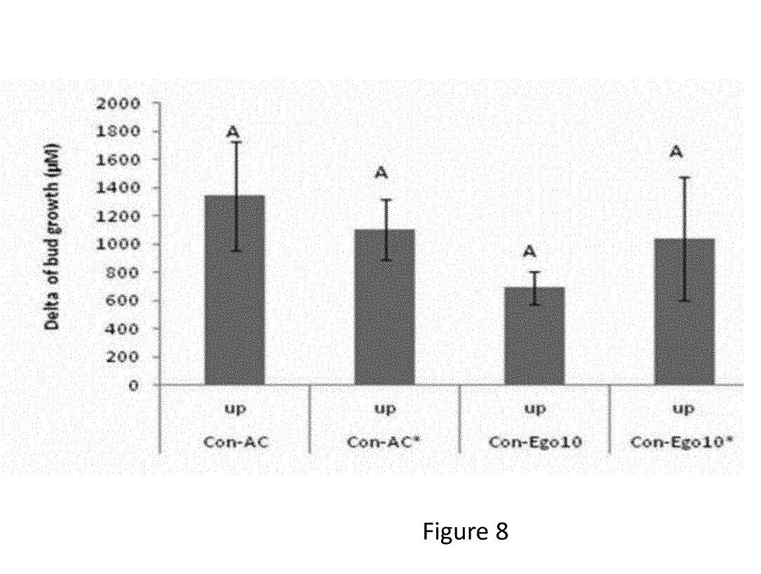

Bud outgrowth following 96, 168 and 264 hours of EGO10 treatment was measured and the length of each bud minus its length at the first day following application was calculated (FIG. 6B). The results demonstrated that application of EGO10 (5 μM) in agar cube of 1.0 cm on the bark led to a significant reduction in bud outgrowth in comparison to control. These results indicate that EGO10 diffuses through the bark stem of olive seedling, leading to bud outgrowth inhibition. Furthermore, scratching the bark led to callus development on the nodes (FIG. 7) and alterations in bud outgrowth (FIG. 8). Taken together, the results show that scratching the olive bark is not required for enhanced penetration of SL analogs, and that EGO10 is able to penetrate the bark.

### Example 4: Hydroxypropyl Cellulose (HPC) Application

As a next step in the development of SL application technology, different substances that can serve as media supporting the diffusion of SLs though the bark of plants were examined. As agar usually contains nutritional compounds, bacteria and fungi can easily contaminate agar cubes. Therefore, other substances were examined, as described hereinbelow. Experiments were performed similarly to those described in Example 3 above, by application of EGO10 in different media on the cutting bark, in plates. Bud outgrowth was monitored as described above.

The use of Hydroxypropyl cellulose (HPC) material instead of agar as the media for EGO10 application on plants was tested. The stabilizing effect of HPC on SL analogs, including EGO10, is described in Example 2 above. For determining which percentage of HPC is suitable for field application, different dilutions of HPC in water were prepared, and their capability to stick to the olive stem was examined.

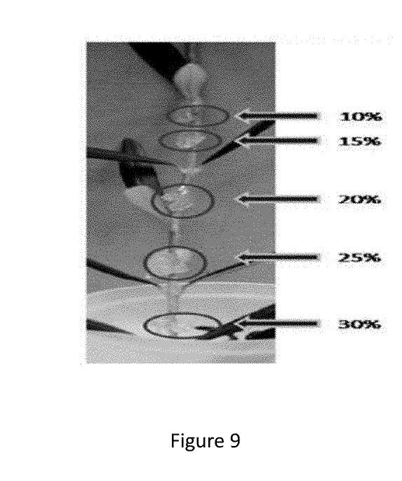

The results showed that 30% HPC was sufficient for sticking to the stem (FIG. 9). Lower percentage of HPC in water remained in the form of liquid, thus found to be not suitable for field application.

### Example 5: Strigolactone Mixed with Hydroxypropyl Cellulose (HPC)

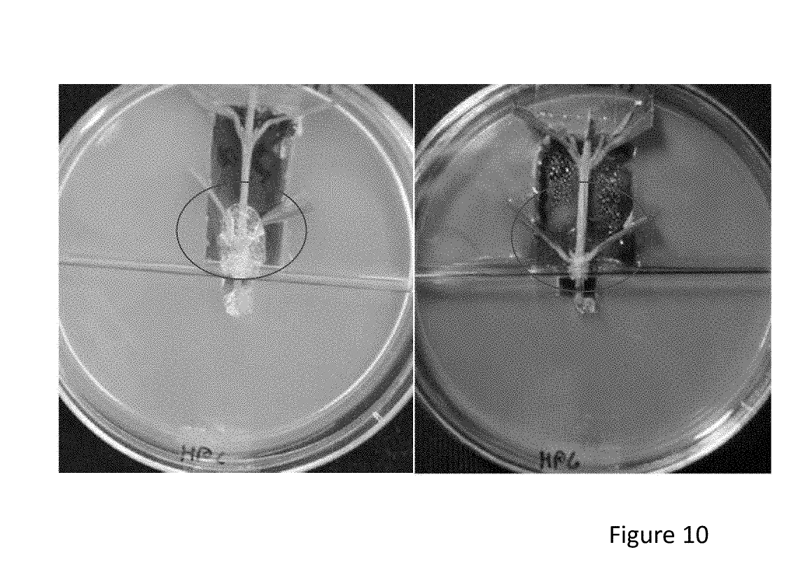

Based on the results above, 30% HPC were mixed with two different concentrations of EGO10; 5 and 10 μM, and applied on the stem of olive seedling (FIG. 10). Bud outgrowth was monitored as described above and the results were compared to those obtained upon using agar cubes (described in Example 3), which served as a positive control.

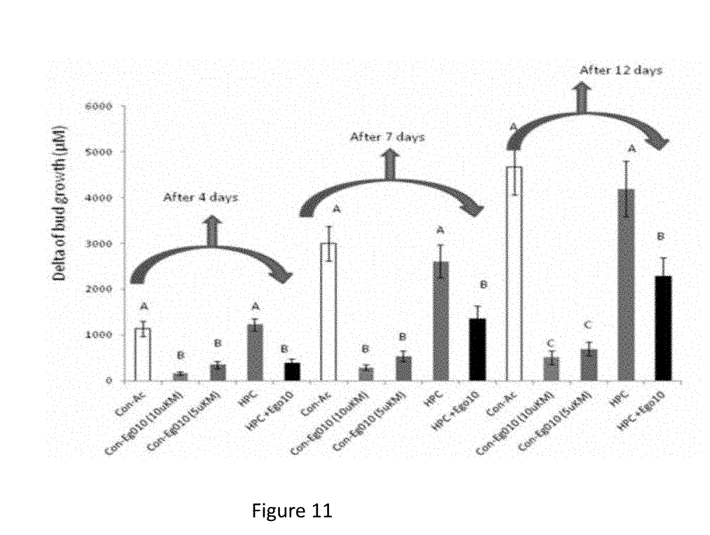

The results showed that both concentrations of EGO10 in 30% HPC reduced bud outgrowth until day 4 post application. However, after day 4 bud outgrowth resumed, whereas EGO10 application using agar cube reduced bud outgrowth throughout the entire experimental period (FIG. 11). These results indicate that HPC is not the most suitable material for SLs application.

### Example 6: Strigolactone Mixed with HPC and Glycerin

In an attempt to improve HPC suitability to the examined system, HPC was mixed with glycerin in the ratio of 3:1. Glycerin, as a known humectant, has the capability to moist materials. In exemplary procedures, 5 μM EGO10 were added to the HPC and glycerin mixture, and then placed on the bark of olive cuttings. Bud outgrowth was monitored as described above.

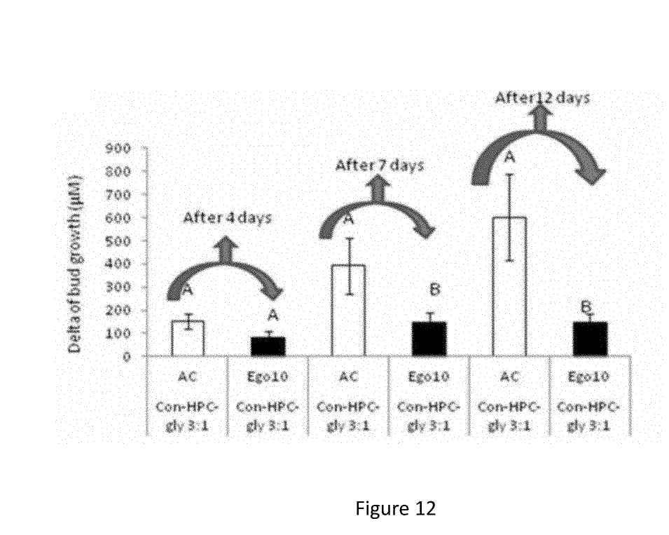

The results show that the mixture of HPC, glycerin and EGO10 inhibited bud outgrowth throughout the experimental period, i.e. until day 12 (FIG. 12). Accordingly, the HPC-glycerin mixture serves as an effective media for EGO10 application to plant stems.

### Example 7: Strigolactone Mixed with PVAc, PVP and HEC

A number of additional possible substances suitable as media for EGO10 application were screened, including polyvinyl acetate (PVAc), polyvinyl pyrrolidone (PVP) and hydroxy ethyl cellulose (HEC). The polymers were used at concentrations of 30% in water, however, as 30% PVP was not solid, it could not be tested. Accordingly, HEC and PVAc were examined for their ability to support EGO10 activity. Bud outgrowth was calculated as described above.

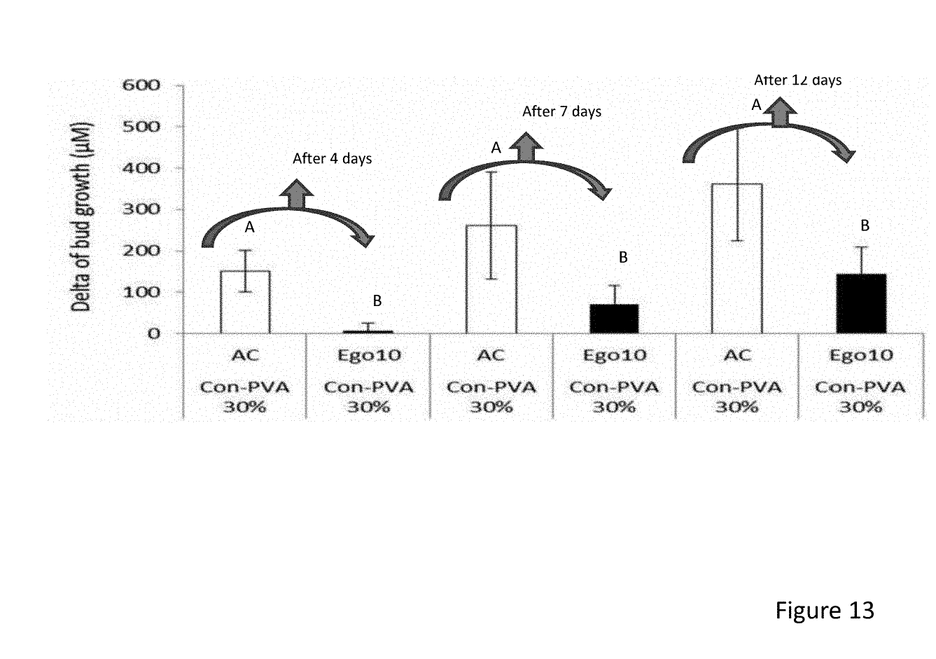

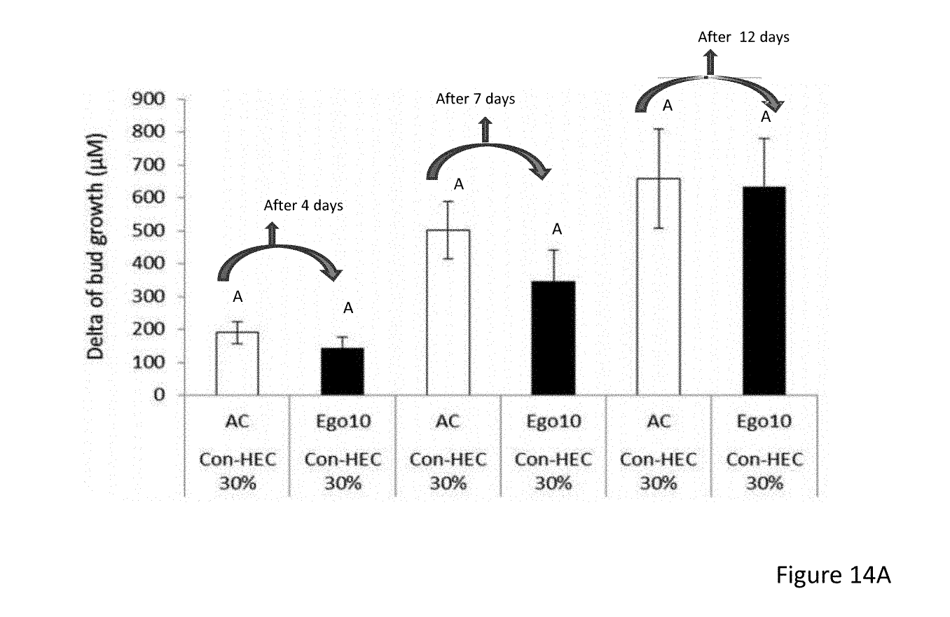

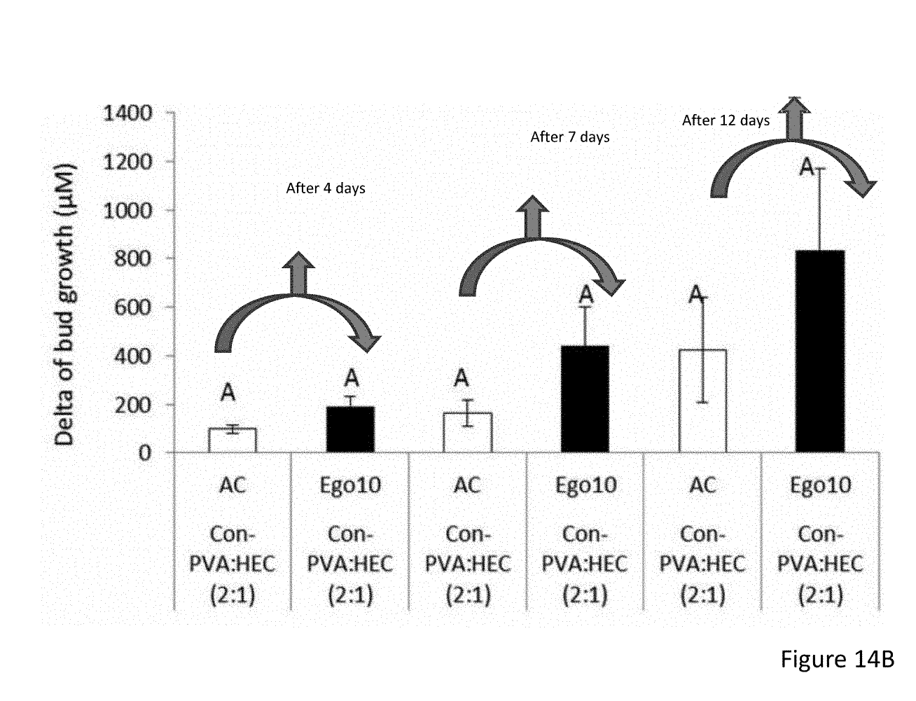

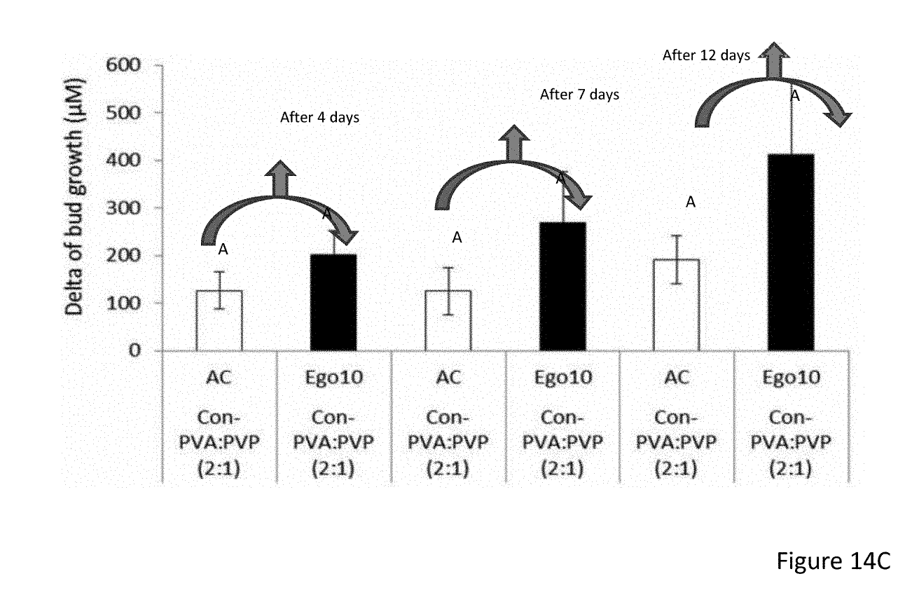

The results indicated that PVAc supported EGO10 activity of bud outgrowth inhibition, while HEC did not (FIG. 13 and FIG. 14A, respectively).

Following, different mixtures of the polymers were examined applied as described above and monitored bud outgrowth. It was found that a mixture of PVA with HEC or PVA and PVP did not sufficiently support EGO10 ability to act to inhibit bud outgrowth (FIG. 14B and FIG. 14C). Without being bound by any particular theory, this might be due to area of brown spots, interpreted as damage to the stem, upon application.

### Example 8: Application EGO10 with HPC+Glycerin, or PVAc by Parafilm Cover

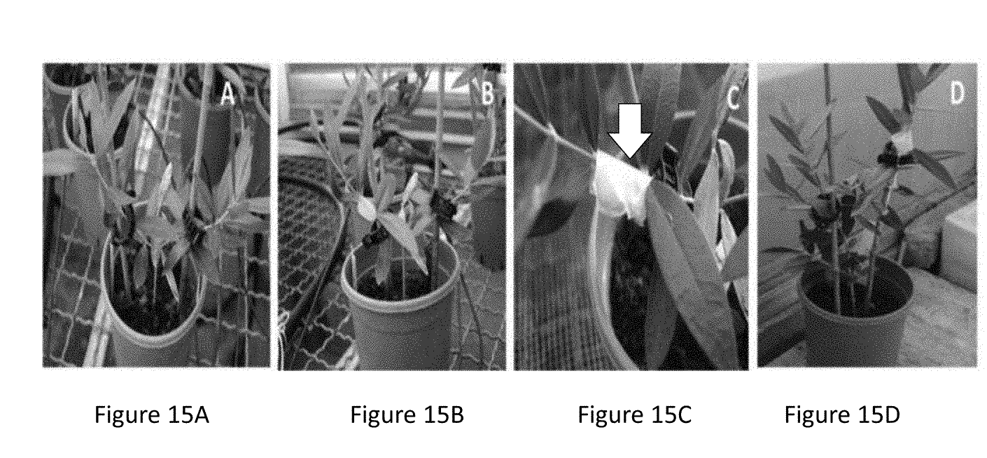

EGO10 either with PVAc, or HPC+glycerin were applied on olive seedling stem by the use of parafilm cover as the apparatus, under greenhouse conditions (FIG. 15). Greenhouse conditions include controlled room temperature of 25° C. In each experiment, 10 plants were used for each treatment. The substances were applied on the stem by a spatula and covered with parafilm. However, under the relatively warm conditions of the greenhouse, after 1 day both HPC+glycerin and PVA liquefied and lost their adhesion to the stem (FIG. 15D, arrow denote some of the liquefied material).

### Example 9: Flexible Plastic Cylinder

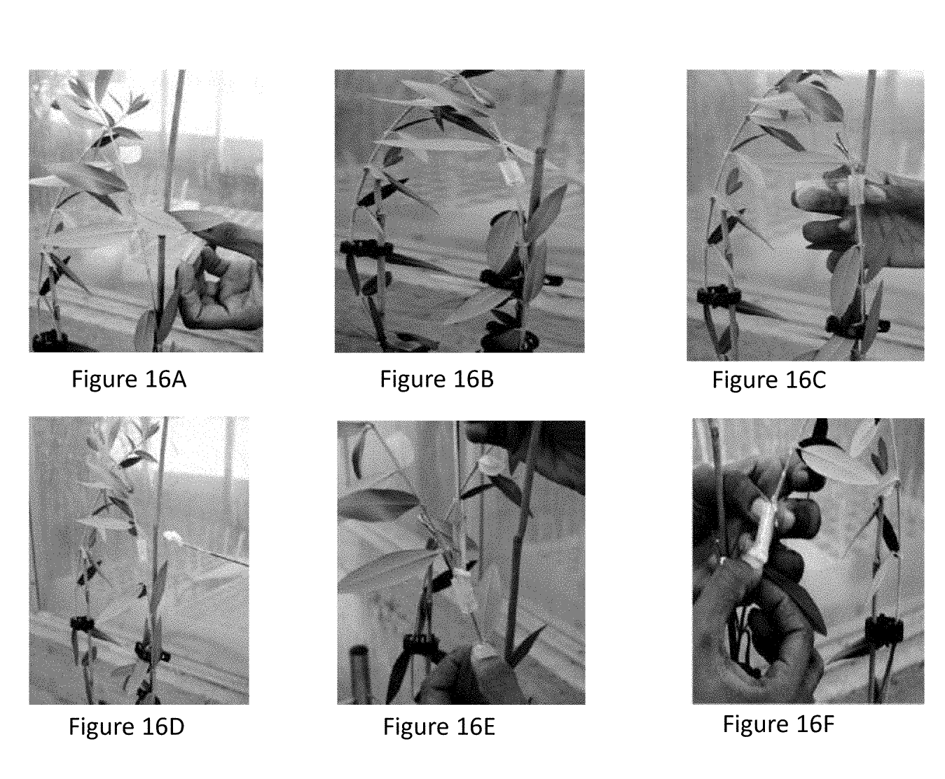

In attempt to improve the performance of the apparatus, different substances and different cover were used. Four formulations were developed and tested. These formulations are based on polysaccharide-sorbent-humidifier substances while the main difference between them is the viscosity of the final product and the ability to retain and release of the active ingredient (EGO 10). All formulations included preservatives against biological decay and were tested under lab condition and were proven to be less heat susceptible, and less likely to liquefy under greenhouse conditions. The cover consisted of a flexible plastic tube that was cut (FIG. 16A), placed on the seedling stem (FIG. 16B) and wrapped with transparent plaster (FIG. 16C). The plastic tubes were filled with the experimental material (FIG. 16D). Moist cotton was placed on both sides of the tubes to minimize water evaporation (FIG. 16E and FIG. 16F). Bud outgrowth was measured for 30 days.

It was concluded that despite their better resistance to greenhouse conditions these substances were not suitable for olive treatments because of their strong retention of the active ingredient and bad release pattern to the plant.

### Example 10: Rigid Plastic Tube

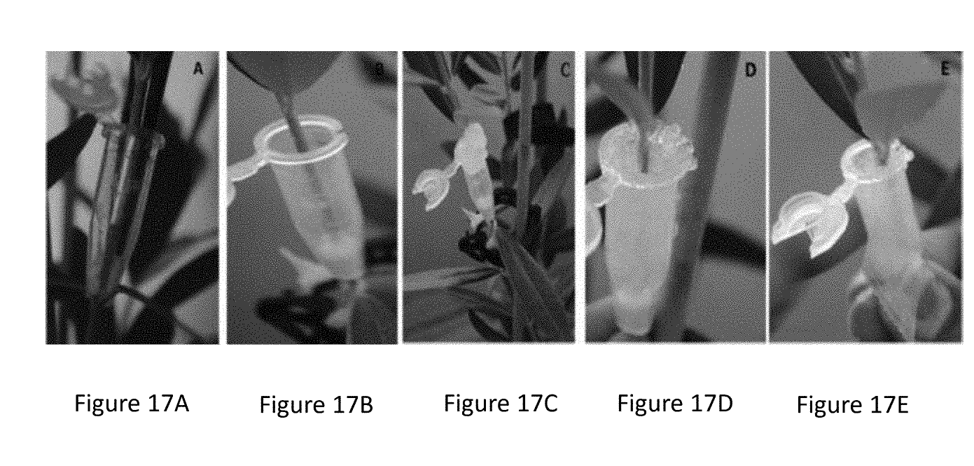

Rigid plastic tubes were tested in order to determine their efficiency as a delivery device for application of the hormone formulations to plants. At first, eppendorf tubes served as prototype. The tubes ware cut from top to bottom and placed on the stem of seedlings. Each tube was sealed with a small moist cotton at the bottom, filled with 1 ml of the examined material and finally covered with transparent plastic tape (FIGS. 17A-17E). The tubes were filled with (HPC+glycerin), or PVAc and EGO10 In each experiment, 10 plants were used for each treatment. Greenhouse conditions include controlled room temperature of 25° C.

### Example 11: EGO10 with HPC and Glycerin or PVAc Application Via Rigid Plastic Tubes Under Greenhouse Conditions

EGO10 (10 μM) or acetone control together with HPC+glycerin or PVAc were applied on the stem of olive cuttings by the use of rigid plastic tubes as described in Example 10 above.

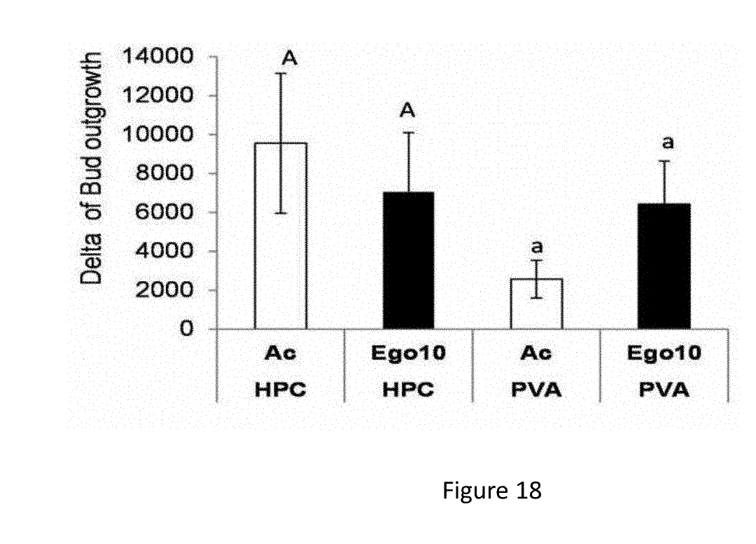

Application of PVAc with the acetone control under the examined conditions led to inhibition of seedling outgrowth (FIG. 18). Therefore, despite the high performance of PVAc in plates, it seems to be not suitable as a stabilizing substance for EGO10 application to olive stem under greenhouse conditions.

On the other hand, use of HPC+glycerin (with acetone) under these conditions did not lead to inhibition of outgrowth (FIG. 18). Moreover, HPC+glycerin with 10 μM EGO10 led to some inhibition of bud outgrowth, without delaying plant growth (FIG. 18). However, control and treatment were not significantly different.

### Example 12: Application of 50 μM EGO10 with HPC and Glycerin Via Rigid Plastic Tubes to Olive Seedlings

Higher concentrations of 50 μM of EGO10 or acetone control were applied with HPC and glycerin using rigid tubes as described in Example 10. Bud outgrowth of olive cuttings was measured until day 30.

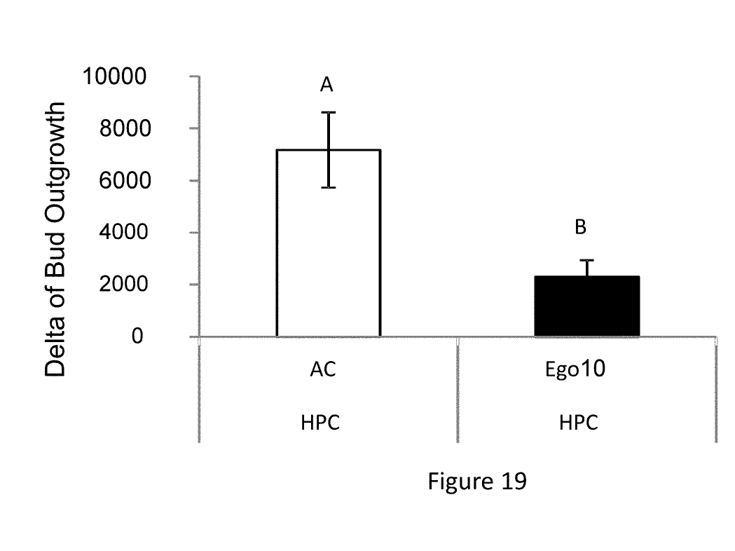

The results indicate that the formulation of 50 μM EGO10+HPC+glycerin significantly inhibits bud outgrowth, compared to control (acetone+HPC+glycerin) (FIG. 19). All treated olive buds grew properly.

### Example 13: Commercial Nursery Conditions

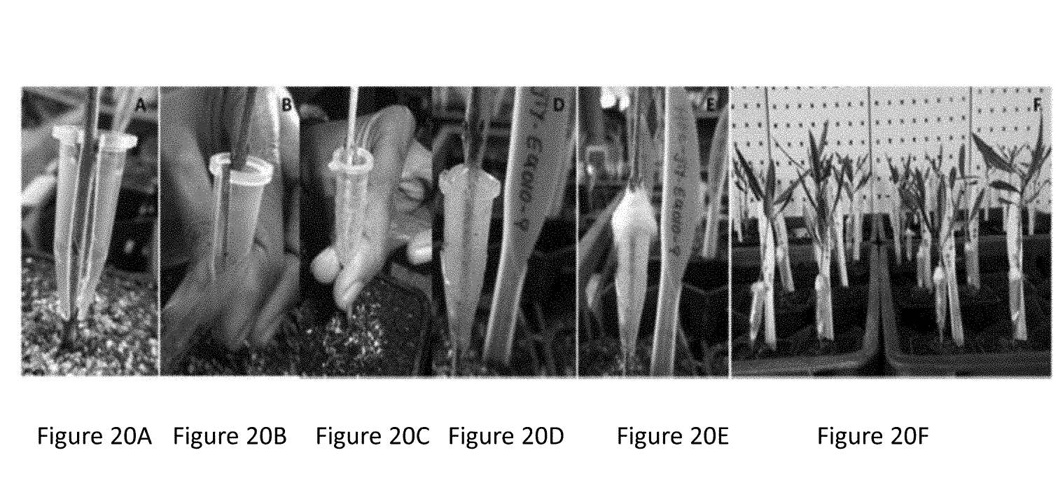

Experiments were performed in AGROGOLD nurseries under commercial nursery conditions, which include nethouse, 40% shed without temperature control. The tested formulations were applied in rigid tubes. Specifically, each eppendorf tube was cut from top to bottom and placed on the stem of the olive seedlings. The tube was sealed and fixed to the plant by cello tape. The tube was completely filled with ˜1 ml of the experimental formulation and then the top was covered with cotton (FIGS. 20A-20F). Each experiment included 10 olive plants for each treatment. The number of wake up buds was counted 75 days following application and the seedlings architecture, general growth and development were examined.

The bud growth effect of EGO10 (50 μM) or acetone control, each supplied together with HPC+glycerin on the stem of the olive cuttings was tested under the nursery conditions.

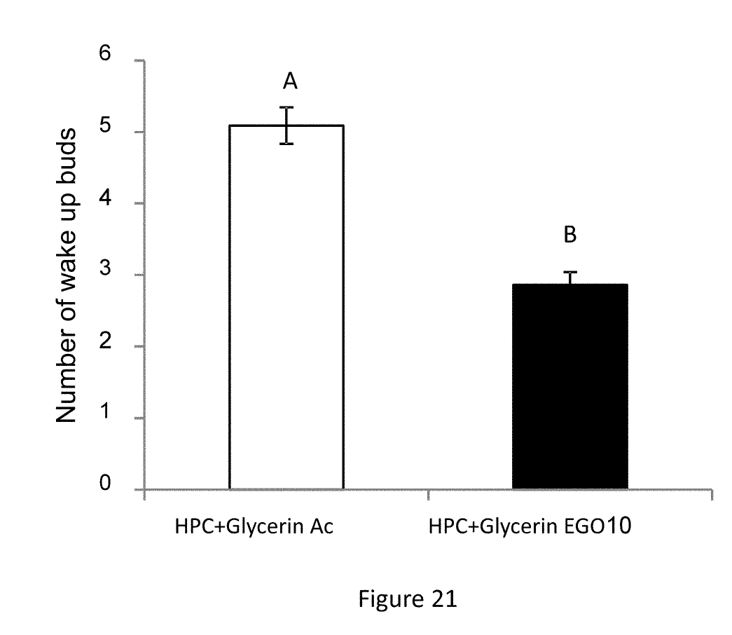

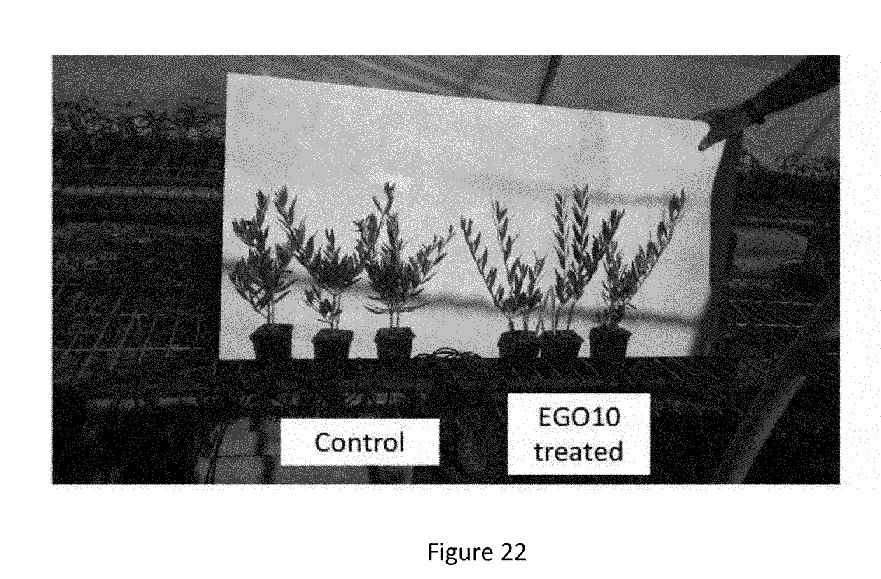

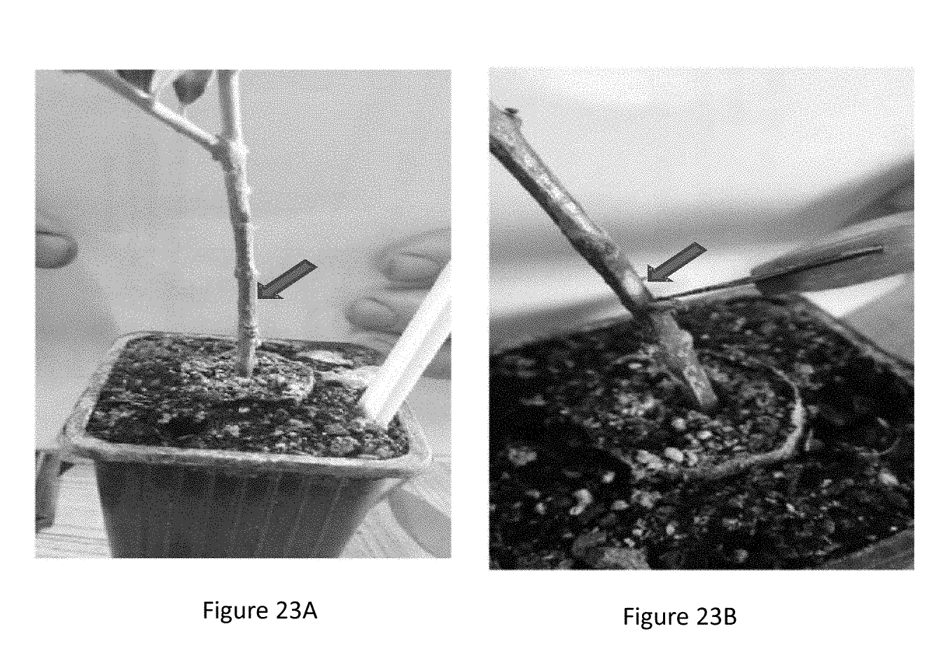

The results show that the formulation of EGO10+HPC+glycerin inhibits bud outgrowth significantly compared to control (acetone+HPC+glycerin), under commercial nursery conditions (FIG. 21). Importantly, seedling outgrowth at that time was not inhibited, and all treated olive buds grew properly (FIG. 22). The control seedlings had a bushy appearance, whereas the plant architecture of the EGO10 treated seedlings included one or two leading branches (FIG. 22). After the termination of the experiment and removal of the apparatus, the application site appeared to be unharmed and functional, as evident by the intact bark and vascular system (FIGS. 23A and 23B, respectively).

### Example 14: Application of EGO10 with HPC and Glycerin Via Rigid Plastic Tubes to Plants Under Commercial Nursery Conditions

Application of EGO10-based collar for a variety of agricultural crops. This was done under greenhouse and commercial nursery conditions. Also, an advanced version of collar in terms of its envelop was developed, for promotion of a cost effective and efficient apparatus for agricultural use, for reduction of axillary branches growth.

EGO10-Collar (and Granules) Application to Multiple Crops Roses (Rosa Hybrida):

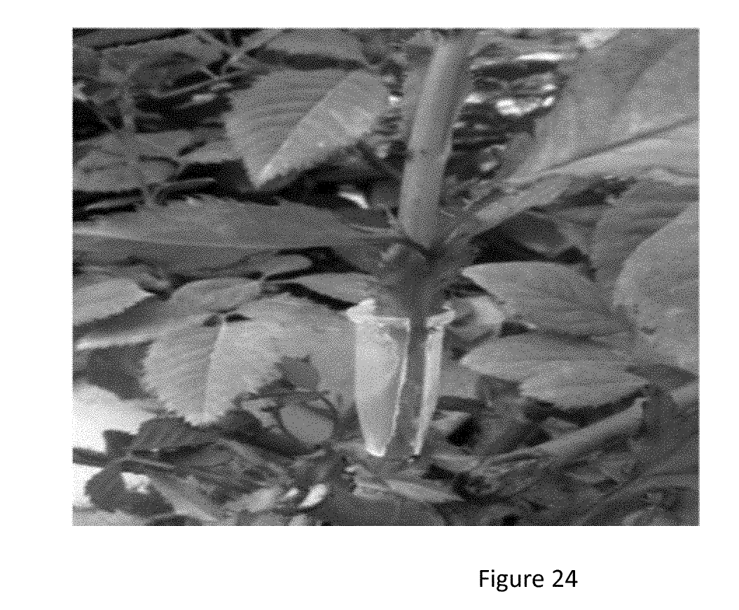

Three replicates on experiments were done in two commercial plots. EGO10 was applied at the indicated concentrations as a collar in Eppendorf tube (FIG. 24).

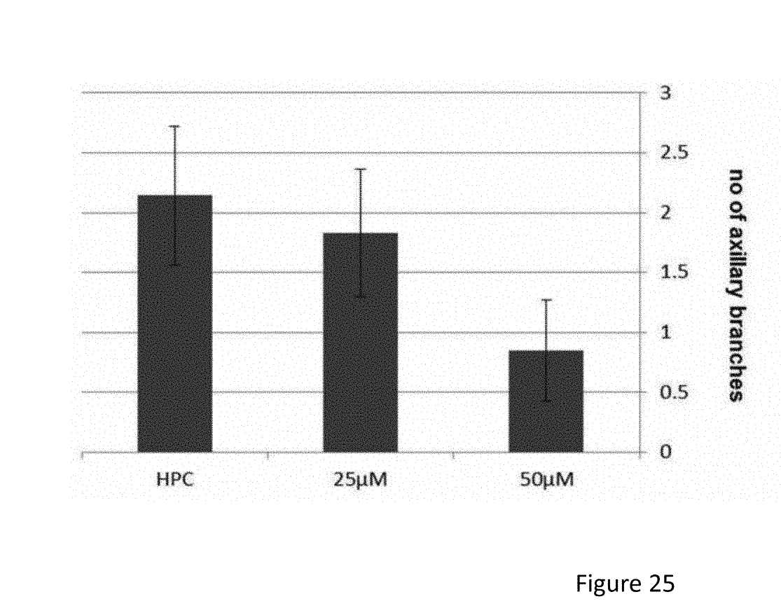

HPC+glycerin and EGO10 (25 or 50 μM), provided in rigid tubes, were applied as described above (Example 13) to roses (Rosa hybrid golden gate). 20 days following application of the formulation by the delivery device, the length of axillary buds (in centimeters) was measured and the number of lateral buds was counted. In all experiment a clear tendency of reduction of lateral branching was determined (FIG. 25). Importantly, application of the collar did not hinder development of “water branches”, which are important for development of branches of flowers.

Application of EGO10 with HPC+Glycerin Via Rigid Plastic Tubes to Hypericum Plants Under Commercial Nursery Conditions:

EGO10 (25 and 50 μM) with HPC+glycerin were applied in rigid tubes, as described above (Example 13) to Hypericum calycinum or Hypericum perforatum (Ivory Spices of Danziger, result of breeding for ornamental).

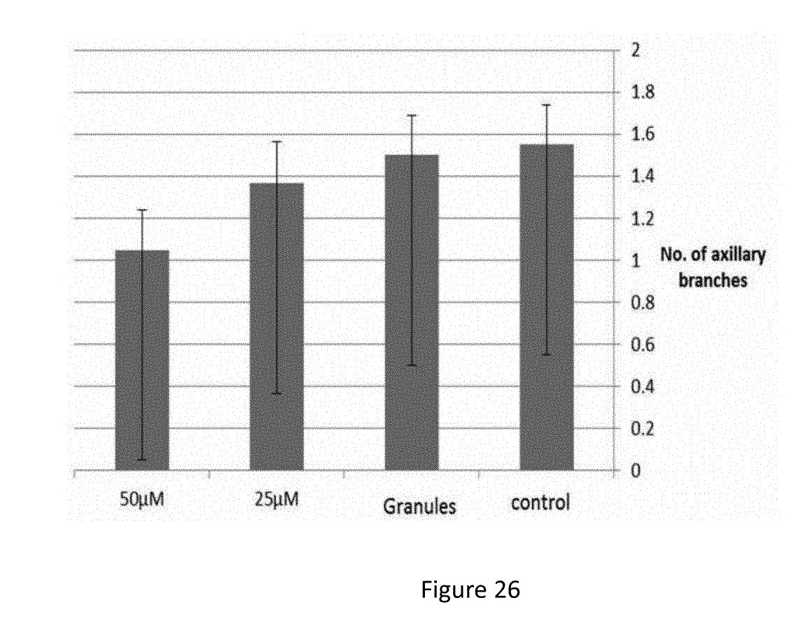

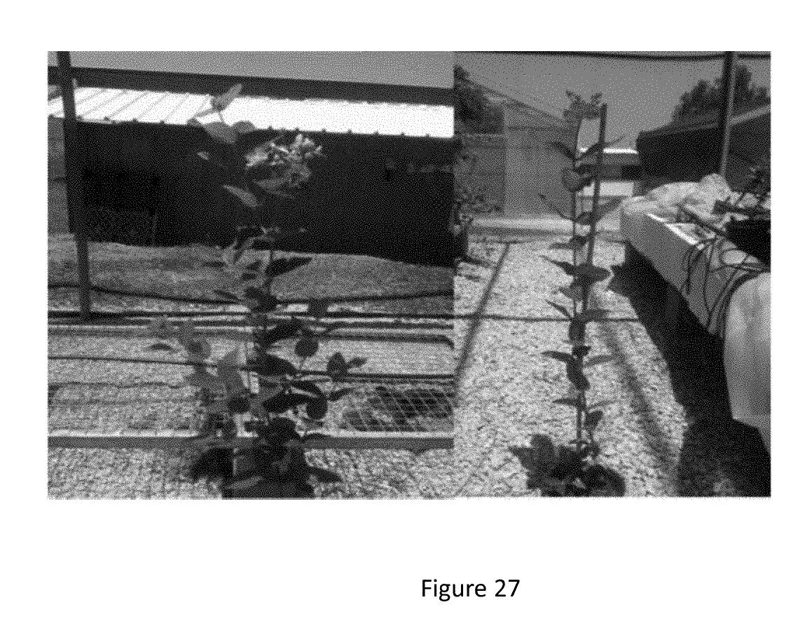

Two replicates on experiments were done in the greenhouse. EGO10 was applied at the indicated concentrations as a collar. Also, EGO10 was applied in another, new way of application—as granules of slow release of 3×10⁻⁸ M—that were applied in the soil, close to the root zone. On Hypericum, this way of application did not result with substantial changes in the no. of axillary branches. In contrast, application of 50 μM EGO10 as collar (in Eppendorf tubes) led to a marked reduction in the no. of axillary branches (FIG. 26). Although results were not significantly different, a clear tendency can be seen. An example to the results of the collar treatment is in FIG. 27.

Pomegranate (Punica granatum):

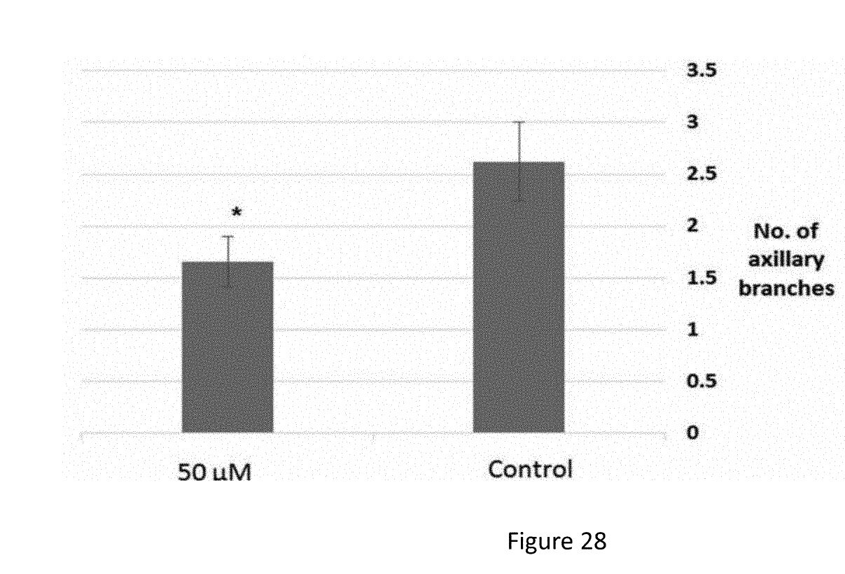

Two replicates on experiments were performed in commercial nursery. Application of 50 μM EGO10 as collar (in Eppendorf tubes) led to a marked and significant reduction in the number of axillary branches (FIG. 28).

Almond (Prunus dulcis):

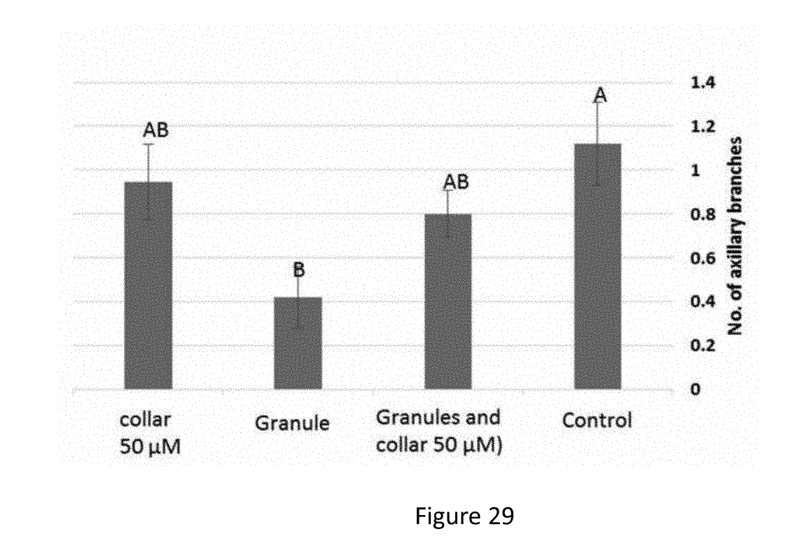

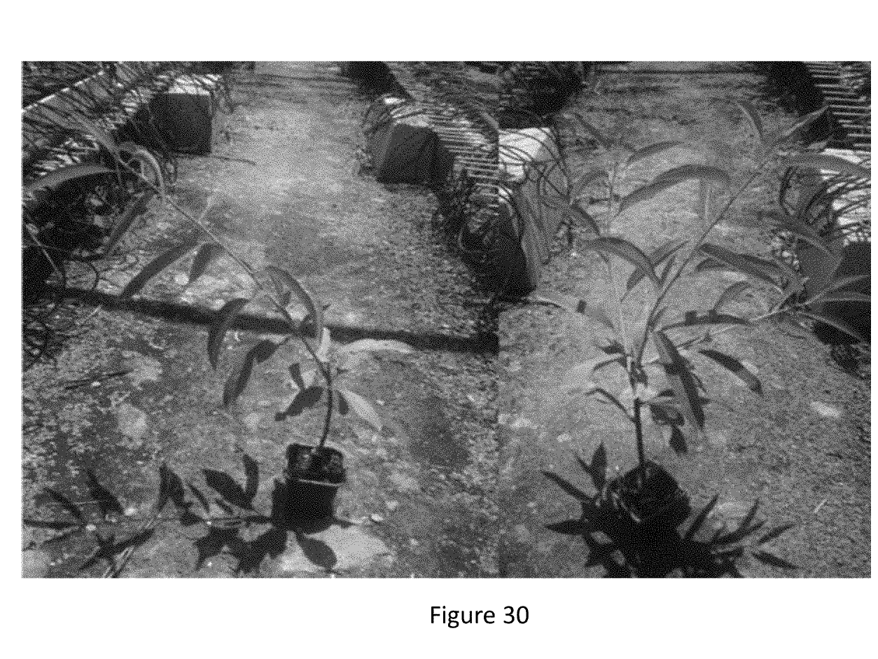

Two replicates on experiments were performed in commercial nursery. Application of 3×10⁻⁸ M EGO10 as granules of controlled release (granules are based on sugar polymers), and not in collar, led to a marked and significant reduction in the number of axillary branches (FIG. 29). Moreover, application of both granules and collar reduced the inhibitory effect of the granules on side branches. Example of the results is shown in FIG. 30.

Olives (Koroneiki olives cultivar):

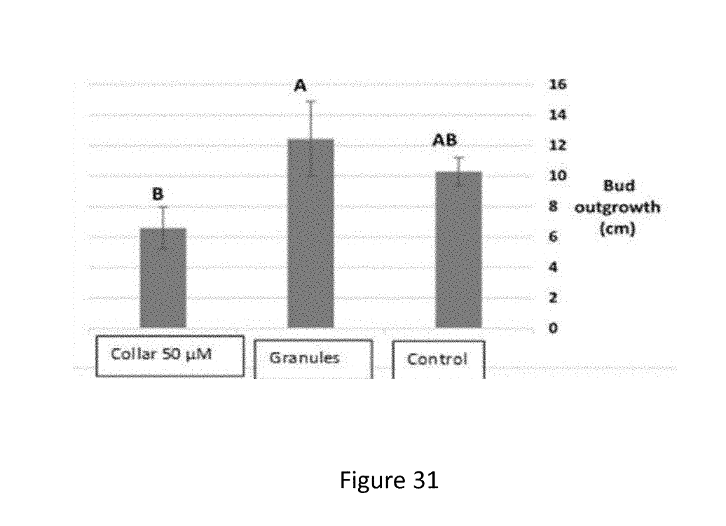

Since Koroneiki olives are one of the most abundant cultivars worldwide, the effect of application of collar of 50 μM and granules that release 3×10⁻⁸ M on development of side branches in this cultivar was examined. The results showed that application of collar was effective in preventing side branches development in Koroneiki olives (FIG. 31).

Tomato (Solanum lycopersicum):

Greenhouse tomato (Shirez, Ikram and other cultivars) are one of the crops that necessitate vast investment in the constant trimming of side branches. Hand labor is needed for this trimming, on an everyday basis, to avoid significant yield loses. The constant trimming is a cause for infection at trimming sites. Hence, adapting collar application to tomato growth may allow to reduce the need for the trimming of side branches. For these experiments two cultivars of greenhouse tomato were used, Ikram and Shirez, both vigorously producing side branches that should be trimmed under commercial growth conditions.

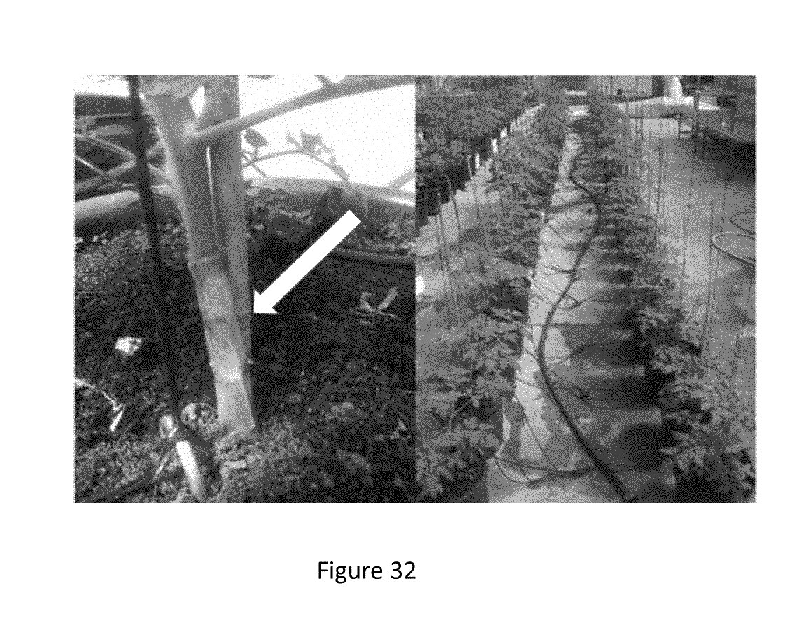

Collar was applied at 25 and 50 μM of EGO10, enveloped by parafilm (application of tube is not feasible on tomato, as it leads to scratching of the stem) as demonstrated in FIG. 32. Also, treatments that include irrigation with 3×10⁻⁶ M (once a week for 6 weeks, 5 ml) and granules application (controlled release at that same concentration of 3×10⁻⁶ M) were applied. Each treatment consisted of 20 plants, blocks of 4 plants were randomly distributed in the greenhouse.

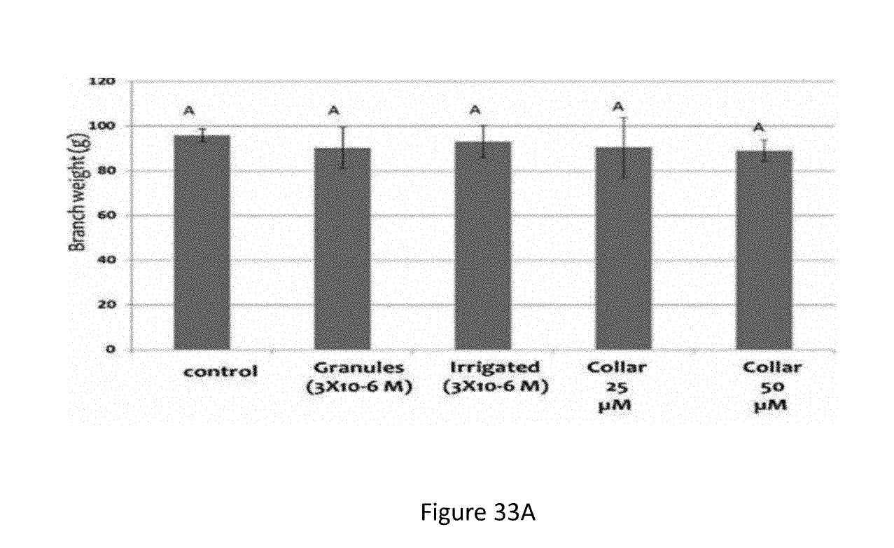

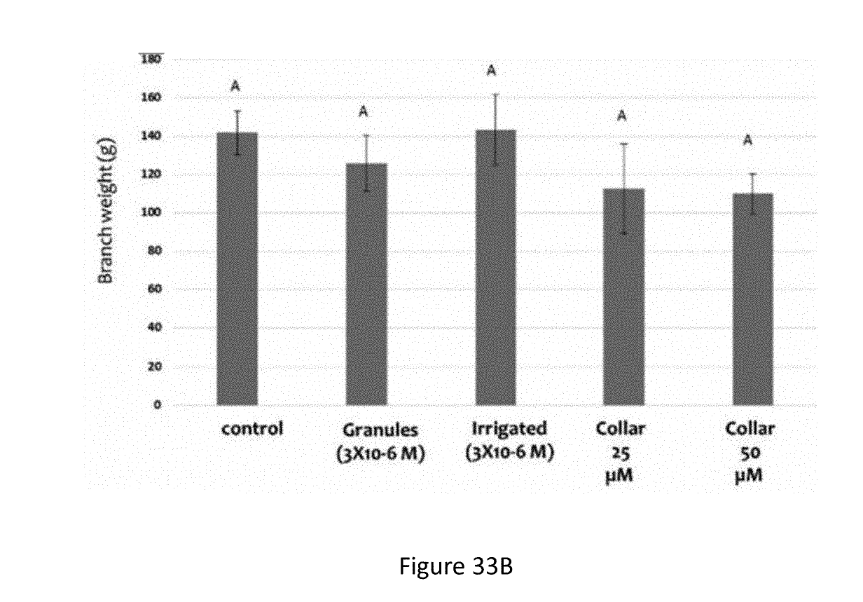

The results (shown as side branch weight) demonstrated that in Shirez, treatments with EGO10 did not change significantly branching (FIG. 33A). However, treatment with EGO10 collars reduced to some extent branching in Ikram (FIG. 33B).

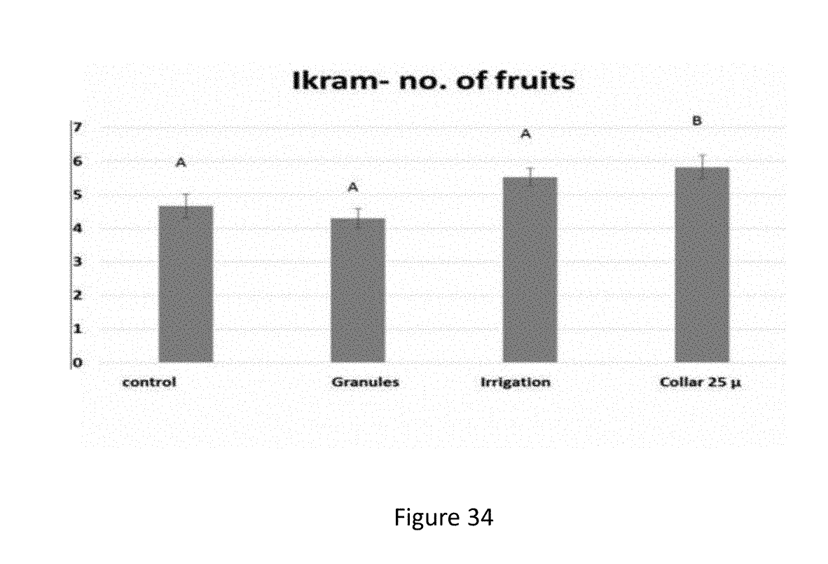

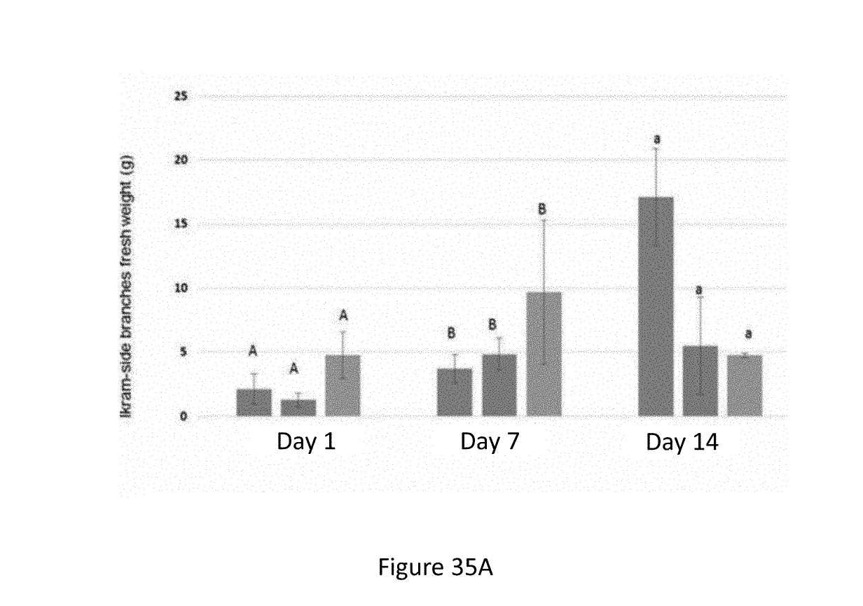

In Ikram, in the same experiment, yield determined as number of fruit was increased in the EGO10 treated plants (FIG. 34).

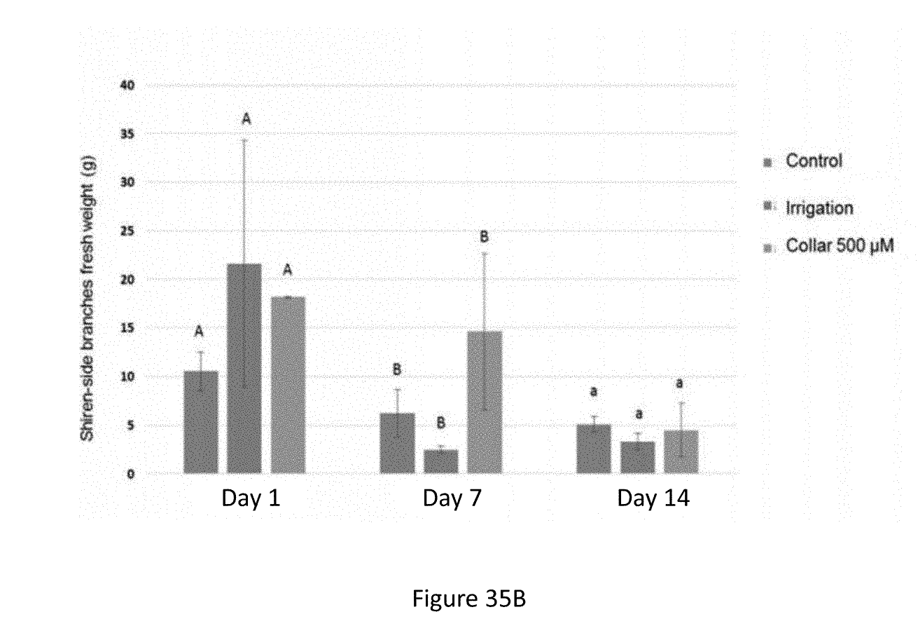

Following, and to increase the possible effect of EGO10 on tomato branching, additional experiment was performed with tomato plants were treated with collar of 500 μM EGO10. Here, although Shirez did not respond to this treatment in Ikram a significant reduction in side branches was determined (FIG. 35).

To summarize, by application of EGO10 as collar, in granules or via irrigation led to reduction of side branches in several agricultural crops.

### Example 15: EGO10 Combined with Auxin

Tomato (Solanum lycopersicum):

The effect of EGO 10 combined with auxin was tested. For this experiments the Ikram cultivar of greenhouse tomato was used since it showed better response to the EGO 10 treatment in the previous experiment. Collar was applied 50 μM of EGO10 (FIG. 32) with a auxin daily spray (IAA) 5 ppm on the shoot tip. Also treatment with only the 50 μM collar of EGO10, an IAA treatment with no collar as a control for the auxin treatment and a control with no treatment were applied. Each treatment consisted of 10-12 plants, blocks of 4 plants were randomly distributed in the greenhouse.

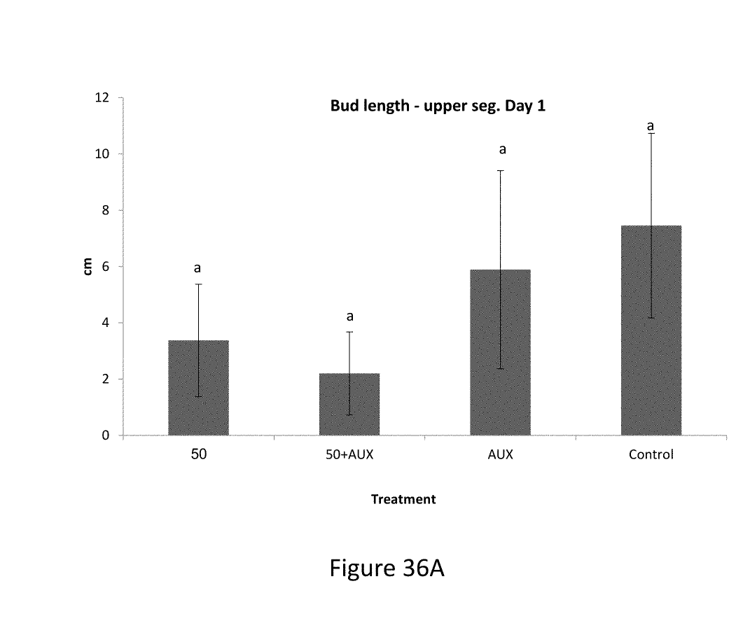

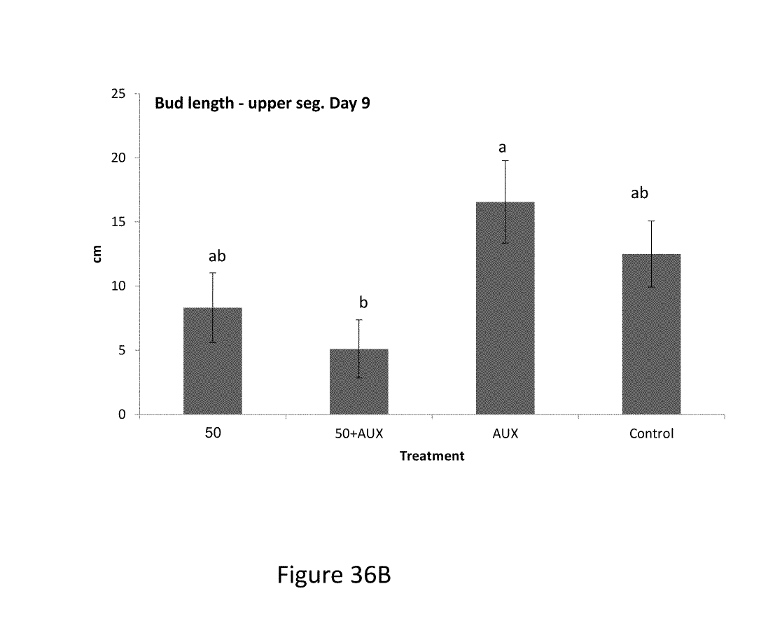

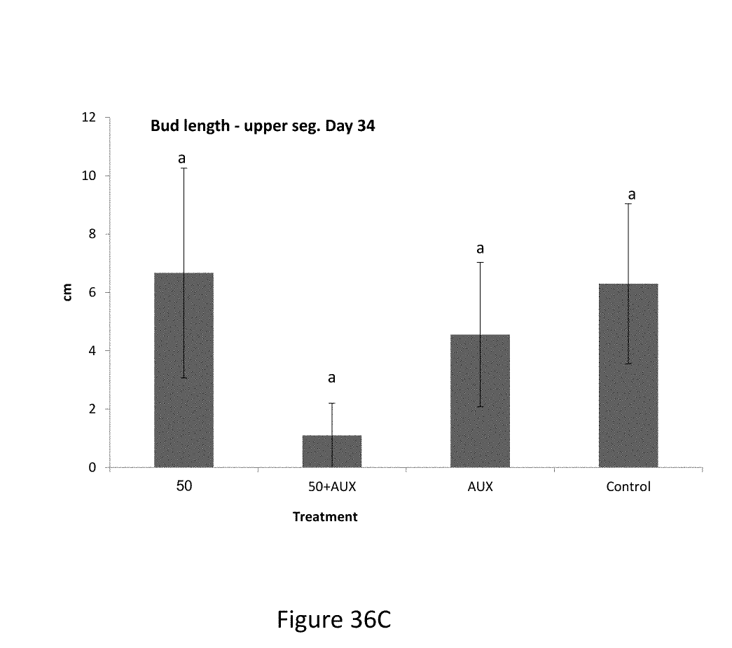

The results were consistent throw the experiment and showed a clear inhibition of bud outgrowth above the Implemented EGO10 collar when auxin was applied. A more moderate and not consistent respond was showed as a result of the EGO10 treatment (FIG. 36).

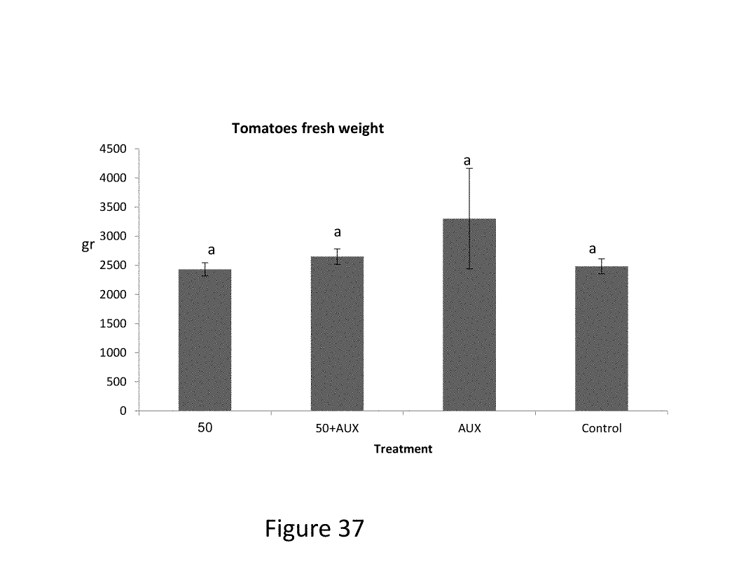

Additionally, there was no negative effect of the treatments on the harvest of the tomatoes (FIG. 37).

### Example 16: Development of Collar Cover for a Cost Effective Application

Another aspect of collar development is development of its cover, or envelop. The hormone and its medium (HPC and glycerin) are needed to be covered with some substance to avoid drying or leaking of the compounds once applied on the stem. Moreover, an environmentally friendly collar was developed, which is based on non-hazardous materials. For that purpose several polymers as collar covers was examined. Table 4 below presents polymers that were tested and their assessment.

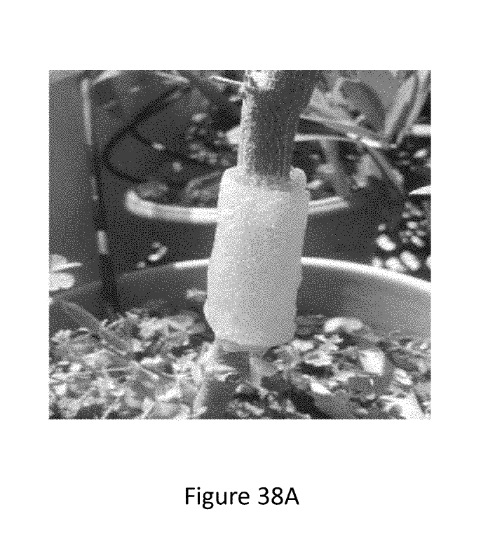

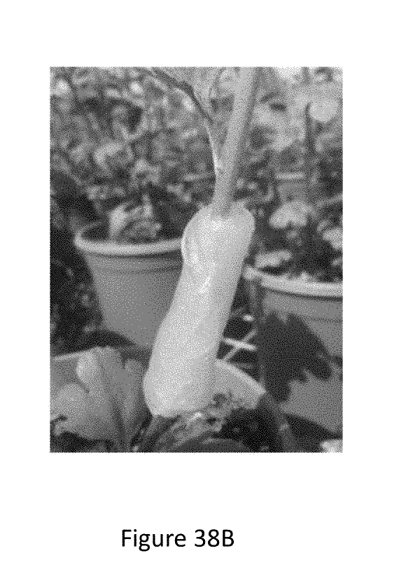

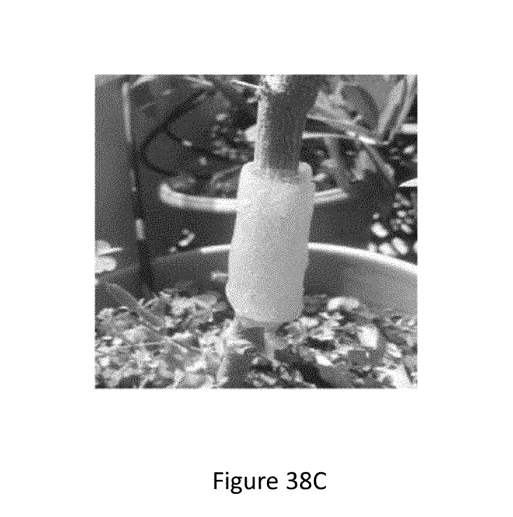

TABLE 4

| Polymer Preparation | Assessment |
|---|---|
| Mix of amylose and amylopectin: | Easy to apply on plant however |
| 8 g Glycerin, 200 μL acetic | flexibility is not sufficient. |
| acid, 43 ml distilled water. | Cracks in outer layer were |
| All materials were mixed and | apparent a few days following |
| heated gradually from 50 to | application (FIG. 38A). |
| 150° C., with constant | |
| steering. When the mixture | |
| became transparent it was | |
| poured into plates and dried | |
| at 90 C. for 2 h. | |
| Mix of amylose and amylopectin, | Improved performance in terms |
| 8 g Glycerin, 200 μL acetic | of flexibility however cracks |
| acid, 43 ml distilled water. All | in outer layer still apparent |
| materials were mixed and heated | a few days following application |
| gradually from 50 to 150° C., | (FIG. 38B). |
| with constant steering. When the | |
| mixture became transparent it was | |
| poured into plates and dried at | |
| 90° C. for 45 min. | |
| Mix of amylose and amylopectin, | Improved version. Application |
| 8 g Glycerin, 200 μL acetic | is easy, flexibility is high, |
| acid, 43 ml distilled water. All | no cracks, seems to be suited |
| materials were mixed and heated | as collar cover. May be used |
| gradually from 50 to 150° C., | commercially (FIG. 38C). |
| with constant steering. When the | |
| mixture became transparent it was | |
| poured into plates and dried at | |
| room temperature. | |

In another exemplary tomato experiment eight polymers that may act as EGO10 carriers and be placed on the plant with no use of any additions were tested. All polymers were less than 0.2 mm thick.

After one week three polymers showed best reaction to the plants were chosen: PEG MW 100000+EGO10; HPC+40% Glycerol; and PVC+50% PEG 600, (referred to as: “POL1”, “POL2”, “POL3”).

With the chosen polymers a tomato experiment was performed. The polymers were charged with EGO10 with the equivalent amount of EGO10 that the 50 μl gel collars contains. In this experiment the effect of the EGO10 polymers with a daily auxin spray (IAA 5 ppm) was tested in comparison to the EGO10 gel collar (following the same procedures as described above with the auxin treatment and a control treatment).

The results are summarized in Table 5 below

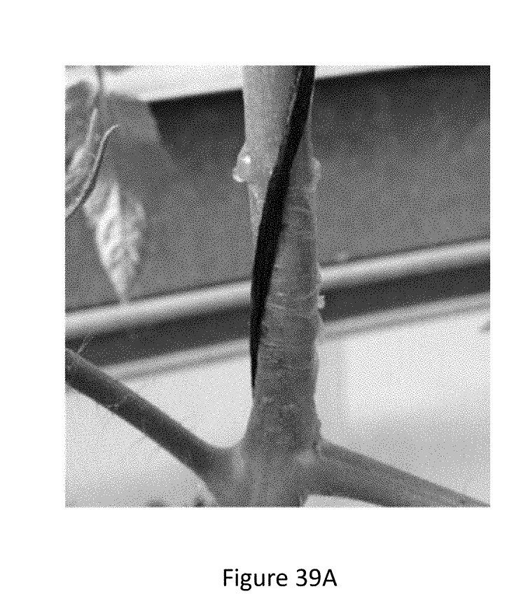

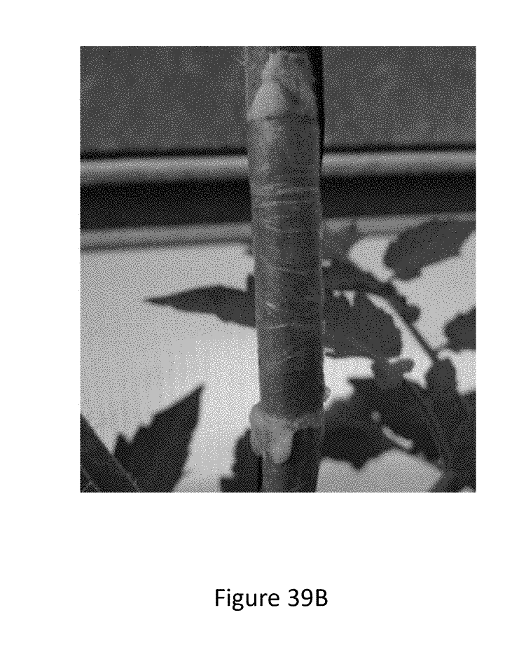

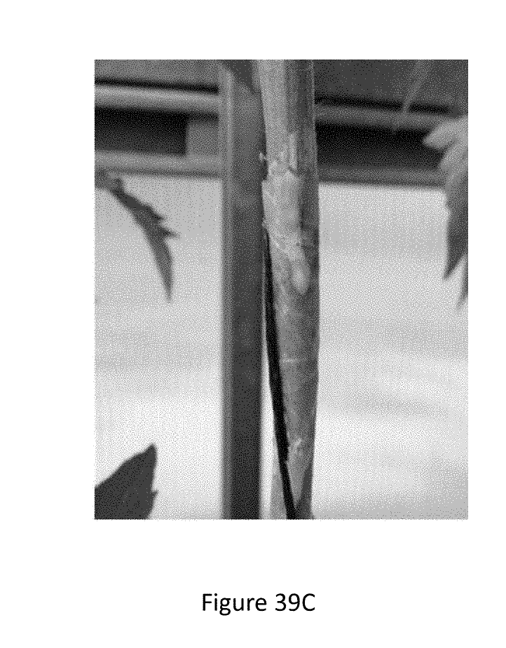

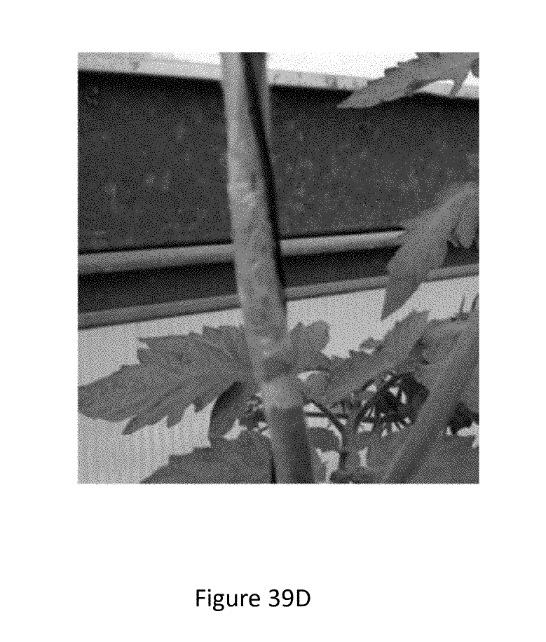

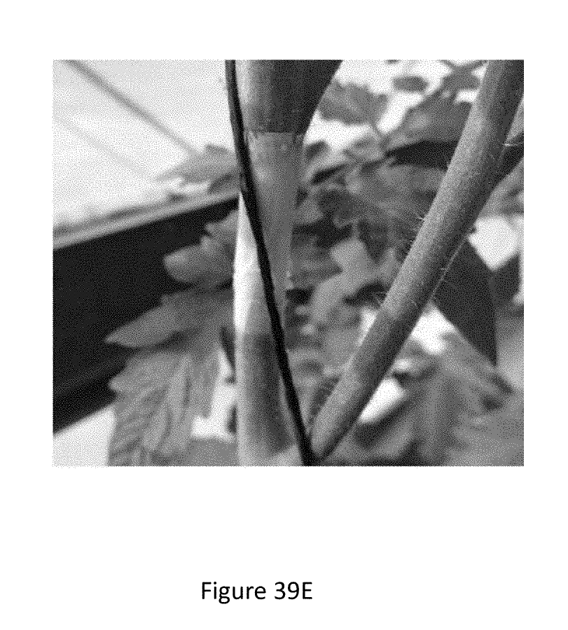

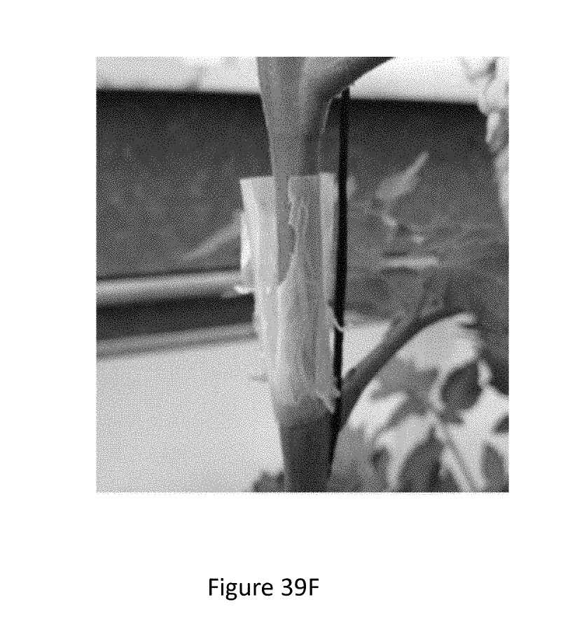

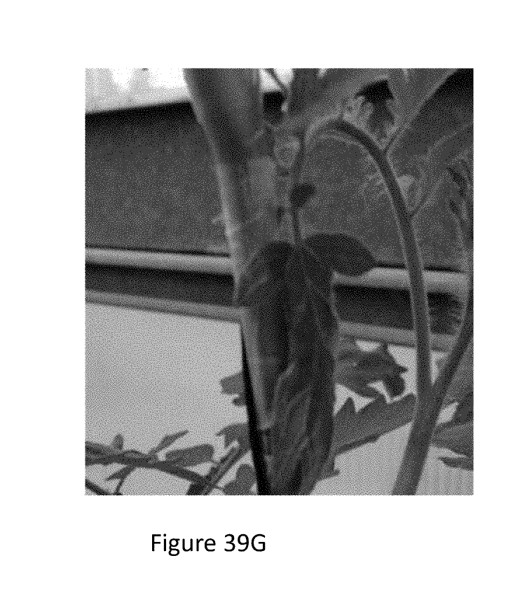

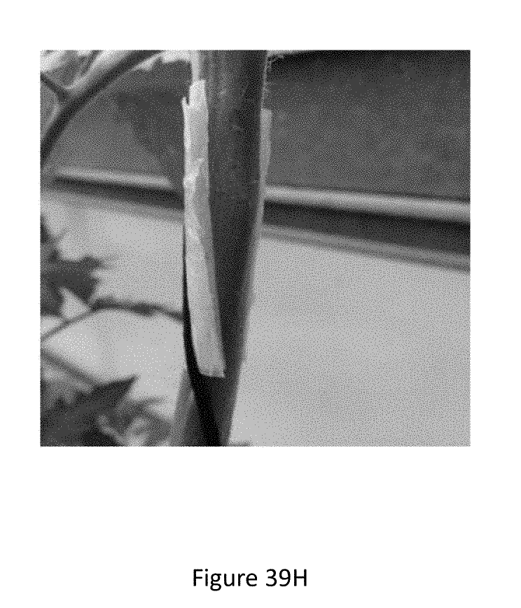

TABLE 5

| Material | Assessment |
|---|---|
| HPC + | Easy to apply. Polymer was melting under parafilm. |
| 40% Glycerol | Fungi developed under the polymer which indicate a |
| | good and humid connection between the polymer and |
| | the stem (FIG. 39). |
| PEG | Easy to apply. Polymer was partly melting under |
| (MW 100,000) | parafilm. Small amount of Fungi were developed |
| | under the polymer (FIG. 39B). |
| PEG | Easy to apply. Polymer was melting under parafilm. |
| | Fungi were developed under the polymer which |
| | indicate a good and humid connection between the |
| | polymer and the stem (FIG. 39C). |
| PEG 100,000 + | Easy to apply. Polymer was partly melting under |
| PEG 600 | parafilm. Small amount of Fungi were developed |
| | under the polymer (FIG. 39D). |
| PVC + | Hard to apply but showed a good connection to |
| 50% PEG 600 | the steam (FIG. 39E). |
| PLA + | Hard to apply. Rejected by the plant (FIG. 39F). |
| 30% dioctyl | |
| sebacate (DOS) | |
| DOC + | Hard to apply. Rejected by the plant (FIG. 39G) |
| 30% Ethoxy | |
| ethanol | |
| DOS (30%) | Hard to apply. Rejected by the plant (FIG. 39H) |
| in PLA | |

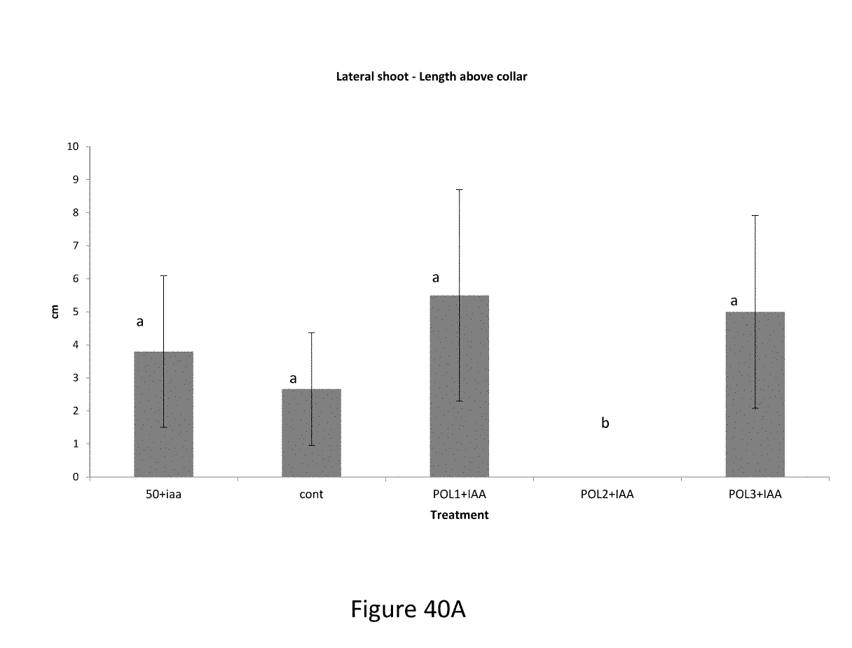

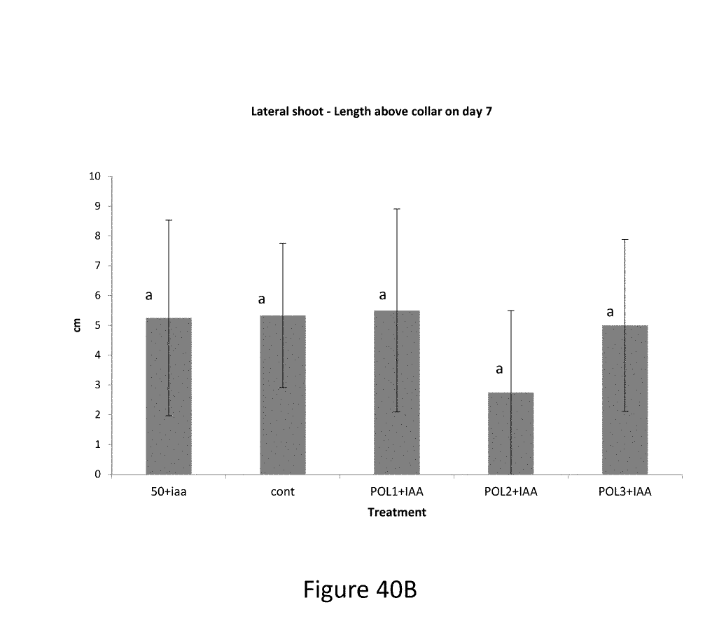

The results showed a clear inhibition of bud outgrowth above the implemented EGO10 collar when POL2 (HPC+40% Glycerol) was applied (FIGS. 40A-B). The other polymers showed similar results to the gel collar (50 μM EGO10+IAA).

Further, Table 6 summarizes some surface free energy (SFE) values for some typical film forming polymers.

TABLE 6

| | SFE | |
|---|---|---|
| Polymer | (mJ/m²) | Comment |
| Fluorinated Ethylene Propylene | 18.5 | Strongly hydrophobic |
| Polydimethyl Siloxane | 20.4 | Strongly hydrophobic |
| Polylactic Acid | 30 | |
| Polyethylene | 33 | |
| Polyvinyl Acetate | 36.5 | |
| Polyoxymethylene | 38.6 | |
| PVC | 40.1 | |
| Polyethylene Oxide | 43 | Hydrophilic |
| Polyvinyl alcohol | 44.2 | Water soluble |
| Hydroxypropyl cellulose | 42-50 | Water soluble |
| Poly hydroxyethyl methacrylate | 56.8 | |
| Polyacrylamide | 52.3 | |

On the basis of these values transparent films were prepared by solvent casting of polyethylene oxide, plasticized PVC, hydroxypropyl cellulose (HPC) and polylactic acid. The films were typically 20-50 microns thick.

As further described hereinabove (e.g., Table 5), to the casting solutions of the high molecular weight polymers, a low molecular weight material (typically <1,000 Daltons) was often added.

Without being bound by any particular mechanism, this low molecular weight material had two functions: 1. To plasticize the polymer film so that it could be wound around a stalk without breaking. 2. To transport the hormone e.g., EGO 10 from the bulk of the polymer to the interface between the film and the stalk.

As noted above, the small molecules tested were glycerol, PEG 600, ethoxy ethanol (all are polar) and dioctyl sebacate (DOS) which is a hydrophobic plasticizer.

The small molecule should meet the requirement of serving as a solvent for the EGO10 and is available in anhydrous forms. Typically, 6 mg of hormone were dissolved in 0.6 ml anhydrous acetone which was then dispersed in the polymer solution.

To summarize, the formulations that adhered to a tomato stalk and those that did not are listed below in Table 7.

TABLE 7

| Adhering Films | Rejected Films |
|---|---|
| Polyethylene Oxide MW = 100,000 | PVC + 30% DOS |
| PVC + 30% PEG 600 | PLA + 20% DOS |
| PVC + 50% PEG 600 | PLA + 30% DOS |
| HPC + 40% Glycerol | PEG 100,000 + 20% PEG 600 |
| | PVC + 30% ethoxy ethanol |

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. A composition comprising at least one polymer characterized by a surface energy having a value that ranges from 20 mJ/m² to 60 mJ/m², and an active agent.

2. The composition of claim 1, wherein said active agent is a plant hormone, optionally, wherein said active agent is at a concentration that ranges from 3 mg/L to 30 mg/L.

3. (canceled)

4. The composition of claim 1, wherein said polymer is selected from polyvinyl acetate (PVAc), polyvinyl alcohol (PVA), hydroxypropyl cellulose (HPC), hydroxy ethyl cellulose (HEC), and polyvinyl pyrrolidone (PVP), polyethylene, and glycol (PEG), or any combination thereof.

5. The composition of claim 1, wherein said polymer is selected from HPC and polyvinyl chloride (PVC).

6. (canceled)

7. The composition of claim 1, further comprising a plasticizer, optionally in the range of 30% to 50%, by weight, optionally wherein said plasticizer is a polymer having a molecular weight (MW) of less than 1000 gr/mole.

8. (canceled)

9. (canceled)

10. The composition of claim 7, wherein said plasticizer is selected from PEG and glycerin.

11. (canceled)

12. The composition of claim 7, wherein said polymer is HPC and the plasticizer is glycerin.

13. The composition of claim 7, wherein said polymer is PVC and the plasticizer is PEG.

14. An article comprising the composition of claim 1, optionally being a delivery device, and optionally configured to wrap the part of the plant.

15. (canceled)

16. The article of claim 14, wherein said device is adapted for installation on a part of a plant, thereby enabling the application of said composition to said plant, optionally wherein the part of the plant is the stem, the bud, the root stock, the trunk, the stalk, or any part of the shoot of said plant.

17. (canceled)

18. The article of claim 14, wherein the delivery device has a cylindrical form, a tube form, a ring form or a clamp form, optionally, wherein said delivery device is made of a rigid, semi-rigid or a flexible material, or any combinations thereof.

19. (canceled)

20. The article of claim 14, wherein the delivery device is made of a biodegradable polymer, composed of pure or blends of bio-plastics, optionally, wherein the biodegradable polymer comprises or is produced from corn starch, potato starch, agar, gelatin, PLA (polylactic acid) or PLGA (poly(lactic-co-glycolic acid)).

21. (canceled)

22. (canceled)

23. The article of claim 14, wherein the active agent is a plant hormone being a compound of formula I: 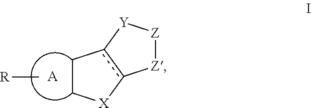
wherein:
A is an aromatic or non-aromatic 5, 6, or 7 carbon atom membered ring;
X is CH₂, NH, or NR′;
Y is CH₂ or O;
Z is CO or -(4-methyl-5-oxo-2,5-dihydrofuran-2-yloxy)-methylene;
Z′ is CO or -(4-methyl-5-oxo-2,5-dihydrofuran-2-yloxy)-methylene;
R is aryl, heteroaryl, NH₂, NHR′, NR′₂, or alkyl;
R′ is aromatic or heteroaromatic ring or alkyl;
or pharmaceutically acceptable salts thereof.

24. The article of claim 23, wherein the plant hormone is a compound of formula II: 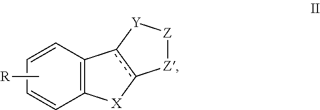
wherein
X is CH₂, NH, or NR′;
Y is CH₂ or O;
Z is CO or -(4-methyl-5-oxo-2,5-dihydrofuran-2-yloxy)-methylene;
Z′ is CO or -(4-methyl-5-oxo-2,5-dihydrofuran-2-yloxy)-methylene;
R is aryl, heteroaryl, NH₂, NHR′, NR′₂, or alkyl;
R′ is aromatic or heteroaromatic ring or alkyl;
or pharmaceutically acceptable salts thereof.

25. The article of claim 23, wherein the compound of formula I is selected from Strigol, Strigyl acetate, Sorgolactone, Orobanchol, Orobanchyl acetate, 5-Deoxystrigol, 2′-Epiorobanchol, Sorgomol, 7-Oxoorobanchol, Solanacol, Fabacyl acetate, Alectrol, 7-Hydroxyorobanchol, 7-Oxoorobanchyl acetate, and 7-Hydroxyorobanchyl acetate.

26. The article of claim 23, wherein the plant hormone is a strigolactone analog, selected from EGO10, GR24, and ST362.

27. The article of claim 23, wherein the plant hormone is EGO10, the medium compound is HPC and the plasticizing agent is glycerin.

28. A method for applying a plant hormone to a plant, comprising providing a composition comprising a polymer and a plant hormone formulation or a delivery device adapted to contain said composition, and installing said composition or said delivery device on a part of the plant, optionally further comprising sealing the delivery device containing the plant hormone formulation. optionally, wherein the part of the plant is the stem, the bud, the root stock, the trunk, the stalk, or any part of the shoot of said plant.

29. The method of claim 28, wherein said plant hormone is provided prior to and/or after the installation of the device, optionally, wherein the plant hormone formulation is provided by filling the device.

30. (canceled)

31. (canceled)

32. (canceled)

33. A composition comprising a natural strigolactone or a strigolactone analog, a polymeric compound, and a plasticizer, for use in decreasing or preventing axillary bud growth in a plant, optionally wherein the strigolactone analog is selected from EGO10, GR24, and ST362, optionally wherein said polymeric compound is selected from PVAc, PVA, HPC, HEC, PVP, PVC, or any combinations thereof, and optionally wherein the plasticizer is glycerin.

34. (canceled)

35. (canceled)

36. (canceled)
